(19) United States
(12) Patent Application Publication
(10) Pub. No.: US 2026/0253854 A1
(43) Pub. Date: Aug. 27, 2026

(54) MACHINE LEARNING PREDICTION OF ION TRAP FILLING FUNCTIONS

(71) Applicant: Thermo Fisher Scientific (Bremen) GmbH, Bremen (DE)

(72) Inventors: Amelia Corinne Peterson, Aalen (DE); Arne Kreutzmann, Bremen (DE)

(21) Appl. No.: 19/061,117

(22) Filed: Feb. 24, 2025

(51) Int. Cl. H01J 49/00; G01N 30/72; G01N 30/86; G06N 20/00

(52) U.S. Cl. CPC H01J 49/0036; G01N 30/72; G01N 30/8693; G06N 20/00

(57) ABSTRACT

Systems/techniques are provided for facilitating machine learning prediction of ion trap filling functions. In various embodiments, a system can access a requested ion population size. In various aspects, the system can cause a mass analyzer to perform a scan using an injection time correlated to the requested ion population size by an ion trap filling function, wherein a coefficient set of the ion trap filling function can be predicted by a machine learning model based on a current operational parameter configuration of the mass analyzer.

### BACKGROUND

Facilitating automatic gain control of a mass analyzer can be considered as a non-trivial task.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate machine learning prediction of ion trap filling functions are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a requested ion population size. In various aspects, the computer-executable components can comprise a scan component that can cause a mass analyzer to perform a scan using an injection time correlated to the requested ion population size by an ion trap filling function, wherein a coefficient set of the ion trap filling function can be predicted by a machine learning model based on a current operational parameter configuration of the mass analyzer.

According to one or more embodiments, a computer-implemented method is provided. In various embodiments, the computer-implemented method can comprise accessing, by a device operatively coupled to a processor, a requested ion population size. In various aspects, the computer-implemented method can comprise causing, by the device, a mass analyzer to perform a scan using an injection time correlated to the requested ion population size by an ion trap filling function, wherein a coefficient set of the ion trap filling function can be predicted by a machine learning model based on a current operational parameter configuration of the mass analyzer.

According to one or more embodiments, a computer program product for facilitating machine learning prediction of ion trap filing functions is provided. In various embodiments, the computer program product can comprise a non-transitory computer-readable memory having program instructions embodied therewith. In various aspects, the program instructions can be executable by a processor to cause the processor to access a requested ion population size. In various instances, the program instructions can be further executable to cause the processor to cause a mass analyzer to perform a scan using an injection time correlated to the requested ion population size by an ion trap filling function, wherein a coefficient set of the ion trap filling function is predicted by a machine learning model based on a current operational parameter configuration of the mass analyzer.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates machine learning prediction of ion trap filling functions in accordance with one or more embodiments described herein.

FIG. 4 illustrates a block diagram of an example, non-limiting system including an ion trap filling function made up of a set of coefficients, a set of tailored coefficient values, a machine learning model, and a training dataset that facilitates machine learning prediction of ion trap filling functions in accordance with one or more embodiments described herein.

FIGS. 5-8 illustrate example, non-limiting block diagrams showing how a set of tailored coefficient values for an ion trap filling function can be obtained in accordance with one or more embodiments described herein.

FIG. 9 illustrates a block diagram of an example, non-limiting system including a determined ion injection time that facilitates machine learning prediction of ion trap filling functions in accordance with one or more embodiments described herein.

FIGS. 10-12 illustrate example, non-limiting block diagrams showing how a determined ion injection time can be obtained using an ion trap filling function with tailored coefficient values in accordance with one or more embodiments described herein.

FIG. 13 illustrates a block diagram of an example, non-limiting system including a resultant ion population that facilitates machine learning prediction of ion trap filling functions in accordance with one or more embodiments described herein.

FIG. 14 illustrates an example, non-limiting block diagram showing how a resultant ion population size can be used to update a machine learning model in accordance with one or more embodiments described herein.

FIG. 15 illustrates an example, non-limiting graph illustrating a difference between linear and non-linear ion trap filling models in accordance with one or more embodiments described herein.

FIG. 16 illustrates some example, non-limiting experimental data in accordance with one or more embodiments described herein.

FIG. 17 illustrates a block diagram of an example, non-limiting operating environment in which one or more embodiments described herein can be facilitated.

FIG. 18 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. It is also evident that new embodiments can be created by combining the embodiments described herein and/or by omitting certain features from the embodiments described therein, as appropriate.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

A mass spectrometer coupled to a chromatograph can be considered as a type of scientific instrument that can be deployed in a scientific, laboratory, research, or clinical operational context or setting, so as to determine the chemical composition or make-up of unknown samples. To facilitate such chemical composition determination, the mass spectrometer or chromatograph can comprise a complex arrangement of actuatable parts (e.g., ion sources, ion lenses, heaters, coolers, columns, ovens, injectors, mass analyzers, fluid valves, fluid pumps, circuit switches), sensors (e.g., ion detectors, voltmeters, thermistors, potentiometers, pressure gauges), or consumables (e.g., carrier fluids, calibrants, filters).

A mass analyzer can be considered as a particularly complicated constituent component of a mass spectrometer. A mass analyzer separates (or, in some cases, measures without physically separating) ions based on their mass-to-charge ratios (based on their m/z values), so that whatever chemical species make up a sample or specimen can be identified or quantified. Different mass analyzers exhibit different physical constructions, designs, or operating principles (e.g., quadrupole mass analyzers versus time-of-flight mass analyzers versus orbital trapping mass analyzers). In order for a mass analyzer to operate properly (e.g., to correctly, accurately, or reliably distinguish ions according to their mass-to-charge ratios), the mass analyzer (or the mass spectrometer of which it is a constituent part) should be able to properly automatically determine what injection time is required to achieve any given or desired ion population size. Such determination is referred to as automatic gain control.

More specifically, a mass analyzer can employ, be made up of, or otherwise be associated with (e.g., be downstream of) ion trapping hardware which can accumulate ions that are emitted by or that originate from some ion source. Automatic gain control can be considered as the task or process of controlling how many ions are physically trapped or accumulated within such ion trapping hardware at any given time. Proper, accurate, or otherwise reliable performance of automatic gain control can heighten the quality of whatever spectral data is produced by the mass analyzer. Indeed, it can help to mitigate space charge effects within the mass analyzer. Additionally, it can help to ensure that the accumulated ion population within the ion trapping hardware is within a measurable dynamic range of the mass analyzer. Furthermore, it can help to ensure that the accumulated ion population within the ion trapping hardware is sufficient for whatever acquisition or scanning technique is being utilized. Conversely, improper, inaccurate, or otherwise unreliable performance of automatic gain control can degrade or deteriorate the quality of whatever spectral data is produced by the mass analyzer. In particular, overfilling the ion trapping hardware can lead to mass discrimination (e.g., in which low or high mass-to-charge ratio ions are lost), detector saturation, or spectral artifacts (e.g., global m/z ratio shifts, Gibb's oscillations).

Existing techniques perform automatic gain control by estimating and linearly scaling an ion flux. More specifically, existing techniques first obtain or estimate a flux ion injection time and a flux ion population size. The flux ion injection time can be a very short duration (e.g., mere milliseconds) and is sometimes referred to as a “pre-scan” or “flux scan.” The flux ion population size can be considered as the number of ions that are accumulated in the ion trapping hardware of a mass analyzer in response to that ion trapping hardware implementing the flux ion injection time. Stated differently, the pre-scan or flux-scan can be one which is the same as, related to, or contains that scan (in terms of types of ions trapped) for which it is desired to estimate the injection time, and the flux ion population size can be the measured ion population of the flux scan or a portion of the measured ion population that is relevant for the scan for which it is desired to estimate the injection time. In any case, when given a target ion population size that is desired to be achieved, existing techniques scale the flux ion injection time by assuming that the ion trapping hardware accumulates ions in a linear fashion with respect to time. Specifically, existing techniques scale the flux ion injection time by the ratio formed between the target ion population size and the flux ion population size. In other words, existing techniques infer or determine that the target ion population size is achievable by an ion injection time that is equal to that linearly-scaled version of the flux ion injection time.

The reliability of such existing techniques is adequate when the target ion population size is close to the flux ion population size. However, the reliability of such existing techniques significantly decreases as the target ion population size gets progressively farther from the flux ion population size. Unfortunately, because the flux ion population size can sometimes be extremely small (e.g., due to the very short duration of the flux ion injection time), and because the target ion population size can sometimes be quite large (e.g., an order of magnitude greater than the flux ion population size), it can be the case that automatic gain control is improperly or unreliably performed by such existing techniques.

Accordingly, systems or techniques that can improve the reliability or accuracy of automatic gain control can be desirable.

Various embodiments described herein can address this technical problem. One or more embodiments described herein can include systems, computer-implemented methods, apparatus, or computer program products that can facilitate machine learning prediction of ion trap filling functions. In particular, the inventors of various embodiments described herein recognized that, contrary to the mathematical assumptions of existing techniques, the ion trapping hardware of a mass analyzer actually behaves non-linearly and in a way that uniquely varies with the particular characteristics or attributes of that ion trapping hardware. Indeed, the present inventors recognized that how the ion trapping hardware accumulates ions as a function of time can be considered as depending, in exponential growth fashion, upon the pseudo-potential well-depth of the ion trapping hardware, the trap radius of the ion trapping hardware, and the Coulombic repulsion of the accumulated ions in the ion trapping hardware. The present inventors realized that, although pseudo-potential well depth, trap radius, and Coulombic repulsion are often not directly measurable or controllable in real-time, such characteristics or attributes can be considered as being indirectly controlled by, influenced by, or otherwise correlated to various operational parameters of the ion trapping hardware (e.g., scan range; isolation width). In other words, such operational parameters can be considered as directly measurable or directly configurable proxies that closely represent or stand in for pseudo-potential well depth, trap radius, and Coulombic repulsion. So, when given the current or present-time operational parameter configuration of the ion trapping hardware, various embodiments described herein can involve utilizing machine learning to predict or infer a specific non-linear function (e.g., exponential growth function) that describes, expresses, represents, or otherwise models the actual accumulation behavior of that ion trapping hardware. By utilizing that predicted or inferred non-linear function, any estimated ion flux can be scaled to accurately or reliably achieve any target ion population size as desired, regardless of how far the target ion population size is from the estimated ion flux. Contrast this with existing techniques, whose reliability deteriorates the farther the target ion population size is from the estimated ion flux.

Various embodiments described herein can be considered as a computerized tool (e.g., any suitable combination of computer-executable hardware or computer-executable software) that can facilitate machine learning prediction of ion trap filling functions. In various aspects, such computerized tool can comprise an access component, a model component, a scan component, or a feedback component.

In various embodiments, there can be a mass spectrometer, which may or may not be operatively coupled in any suitable fashion to a chromatograph. In various aspects, the mass spectrometer can comprise any suitable constituent hardware (e.g., any suitable ion beam emitter; any suitable ion detector; any suitable ion optics equipment). In various instances, such constituent hardware can include a mass analyzer exhibiting any suitable design, construction, or architecture (e.g., quadrupole mass filter analyzer, time-of-flight (TOF) analyzer, electrostatic trap or orbital trapping (e.g., ORBITRAP™) mass analyzer, or Fourier transform ion cyclotron resonance (FT-ICR) mass analyzer).

In various cases, the mass analyzer can have or be associated with any suitable type of ion trapping hardware, and such ion trapping hardware can have any suitable types of configurable operating parameters. In various aspects, a configurable operating parameter can be any suitable selectively-controllable characteristic or setting that governs the behavior of the ion trapping hardware and that can be directly adjusted or changed in response to electronic instructions or commands received from a user. For example, such configurable operating parameters can include a scan range implemented by the mass analyzer; first, last, or center masses implemented by an upstream quadrupole of the mass analyzer; or an isolation width implemented by the mass analyzer. In various instances, the configurable operating parameters of the ion trapping hardware of the mass analyzer can have a current or present-time configuration (e.g., can be currently or presently set to specific or certain values).

In any case, it can be desired for the mass analyzer to perform a scan on any suitable sample or specimen using an ion population size that is requested by a user or technician (e.g., that is indicated by the user or technician via a graphical user interface of the mass analyzer). In various aspects, the computerized tool can facilitate such scan as described herein.

In various embodiments, the access component of the computerized tool can electronically access the mass spectrometer. That is, the access component can electronically interface with the mass spectrometer, such that any other components of the computerized tool can electronically interact with (e.g., send electronic commands to, read electronic signals from) the mass spectrometer and thus the mass analyzer. Accordingly, the access component can electronically receive, retrieve, or otherwise obtain: the current or present-time configuration of the operating parameters of the ion trapping hardware; or the requested ion population size. Thus, any other component of the computerized tool can interact with (e.g., read, write, edit, copy, manipulate, utilize): the current or present-time configuration of the operating parameters of the ion trapping hardware; or the requested ion population size.

In various embodiments, the model component of the computerized tool can electronically store, maintain, control, or otherwise access an ion trap filling function. In various aspects, the ion trap filling function can be any suitable non-linear mathematical function (e.g., an exponential growth function) that takes as an input argument an ion population size (or a normalized version thereof) and that produces as output an ion injection time (or a normalized version thereof) needed to achieve that inputted ion population size. It should be understood or otherwise appreciated that, in some cases, the ion trap filling function can take any other suitable input arguments as desired or appropriate (e.g., can, in some situations, receive as input a flux ion injection time and a flux ion population size in addition to any given or desired ion population size). In various instances, the ion trap filling function can be defined by a set of coefficients whose mathematical application to the inputted ion population size yields the outputted ion injection time. Accordingly, the specific ion injection time that the ion trap filling function produces as output for any given inputted ion population size can depend upon what values are chosen, selected, or used for the set of coefficients. In various cases, the model component can electronically determine or compute what specific values of the set of coefficients would cause the ion trap filling function to accurately or reliably represent or model the transient accumulation of ions within the ion trapping hardware of the mass analyzer, based on the current or present-time configuration of the configurable operating parameters of the ion trapping hardware. In various aspects, the model component can facilitate such determination or computation, by leveraging a machine learning model.

Specifically, the model component can electronically store, maintain, control, or otherwise access the machine learning model. In various aspects, the machine learning model can exhibit any suitable artificial intelligence internal architecture. For instance, the machine learning model can exhibit any suitable type of deep learning neural network internal architecture. For example, the machine learning model can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the machine learning model can include any suitable numbers of neurons in various layers (e.g., different layers can have the same or different numbers of neurons as each other). As yet another example, the machine learning model can include any suitable activation functions (e.g., softmax, sigmoid, hyperbolic tangent, rectified linear unit) in various neurons (e.g., different neurons can have the same or different activation functions as each other). As still another example, the machine learning model can include any suitable interneuron connections or interlayer connections (e.g., forward connections, skip connections, recurrent connections). However, in other cases, the machine learning model can exhibit any other suitable type of internal architecture (e.g., support vector machine architecture, random forest regressor architecture, naïve Bayes architecture).

Regardless of its specific internal architecture, the machine learning model can be considered as a type of regressor that can map, link, or otherwise correlate: values of the configurable operating parameters of the ion trapping hardware; to values for the set of coefficients of the ion trap filling function. That is, the machine learning model can be configured to receive as input any given ion trapping hardware parameter configuration and to compute as output coefficient values that would cause the ion trap filling function to accurately or reliably represent the real-world transient accumulation behavior of whatever hardware is utilizing that given ion trapping hardware parameter configuration.

Accordingly, in various embodiments, the model component can execute the machine learning model on the current or present-time configuration of the operating parameters of the ion trapping hardware, and such execution can yield tailored or customized values of the set of coefficients of the ion trap filling function. As a non-limiting example, suppose that the machine learning model is a deep learning neural network. In such case, the model component can feed the current or present-time configuration of the operating parameters of the ion trapping hardware to an input layer of the machine learning model. In various aspects, the current or present-time configuration can complete a forward pass through one or more hidden layers of the machine learning model, and an output layer of the machine learning model can compute or calculate the tailored or customized coefficient values, based on whatever hidden activations are produced by the one or more hidden layers. In various instances, the tailored or customized coefficient values can be considered as being whatever specific values of the set of coefficients that would cause the ion trap filling function to accurately or reliably model the real-world accumulation behavior of the ion trapping hardware of the mass analyzer.

In order for various embodiments described herein to function properly, the machine learning model can first be trained. In various aspects, the model component can facilitate such training (e.g., in supervised fashion), as described later herein.

In various embodiments, the scan component of the computerized tool can electronically determine an ion injection time that, if implemented by the ion trapping hardware of the mass analyzer, would achieve the requested ion population size, by leveraging the tailored or customized coefficient values predicted by the machine learning model. As a non-limiting example, the scan component can respectively assign the tailored or customized coefficient values to the set of coefficients of the ion trap filling function, thereby causing the ion trap filling function to take on some specific or particular shape, and the scan component can subsequently feed the requested ion population size as an input argument to the ion trap filling function. In some cases, whatever scalar output that the ion trap filling function produces can be considered as the determined ion injection time. In other cases, that scalar output can be: multiplied by a flux ion injection time; and divided by the result produced by applying the ion trap filling function to a flux ion population size that is achieved when the mass analyzer implements that flux ion injection time. The mathematical result of such operations can be considered as the determined ion injection time. In various instances, once the determined ion injection time is obtained, the scan component can electronically cause the mass analyzer to perform (e.g., on any suitable sample) a scan utilizing the determined ion injection time.

In various embodiments, the feedback component of the computerized tool can electronically update the machine learning model in a real-time or online learning fashion. As a non-limiting example, the feedback component can measure whatever actual ion population size is achieved within the mass analyzer as a result of implementing the determined ion injection time. In various aspects, the feedback component can compute any suitable error (e.g., mean absolute error) between the requested ion population size and that measured ion population size. In various instances, the feedback component can incrementally update (e.g., via backpropagation) internal parameters (e.g., weight matrices, bias values) of the machine learning model, based on that error.

In any case, various embodiments described herein can be considered as facilitating automatic gain control via the artificial intelligence prediction of non-linear ion accumulation behavior of a mass analyzer. Such embodiments can more accurately compute or calculate what ion injection times are needed to achieve desired ion population sizes, as compared to existing techniques that erroneously assume linear ion accumulation behavior.

Various embodiments described herein can be employed to use hardware or software to solve problems that are highly technical in nature (e.g., to facilitate machine learning prediction of ion trap filling functions), that are not abstract and that cannot be performed as a set of mental acts by a human. Further, some of the processes performed can be performed by a specialized computer (e.g., mass spectrometers coupled to liquid, gas, or ion chromatographs; deep learning neural networks composed of weight matrices or convolutional kernels) for carrying out defined acts related to the field of automatic gain control.

For example, such defined acts can include: accessing, by a device operatively coupled to a processor, a requested ion population size; and causing, by the device, a mass analyzer to perform a scan using an injection time correlated to the requested ion population size by an ion trap filling function, wherein a coefficient set of the ion trap filling function is predicted by a machine learning model based on a current operational parameter configuration of the mass analyzer. In some aspects, such defined acts can include: feeding, by the device, the current operational parameter configuration as input to the machine learning model, wherein the machine learning model produces as output the coefficient set.

Such defined acts are inherently computerized. Indeed, a mass spectrometer is a highly-technical computerized device comprising specific computerized hardware (e.g., temperature sensors, pressure sensors, voltage sensors, ion beam emitters, electron beam emitters, focusing lenses, ion detectors, electron detectors, beam apertures, fluid valves). A mass spectrometer, the operations that it performs, and the mass spectra that it captures cannot be implemented by the human mind, or by a human with mere pen and paper, in any reasonable or practicable way without computers. Furthermore, a mass analyzer is a specific, tangible constituent piece of hardware in various scientific instruments that separates, arranges, orders, measures, or otherwise distinguishes ions according to mass-to-charge ratio. A mass analyzer and the ion-distinguishing functionality that it performs cannot be implemented in any way whatsoever by the human mind or by a human with mere pen and paper. Further still, machine learning models, such as artificial neural networks, are inherently computerized constructs comprising specific software-oriented architectures (e.g., input layers, hidden layers, or output layers, any of which can be made up of trainable or non-trainable internal parameters such as convolutional layers or LSTM layers). Machine learning models cannot be trained, executed, or updated by the human mind, or by humans with mere pen and paper, in any reasonable or practicable way without computers.

Moreover, various embodiments described herein can integrate into a practical application various teachings relating to the field of automatic gain control. As explained above, automatic gain control is the task or process of determining what ion injection time would, if implemented by a mass analyzer or by whatever ion trapping hardware is associated with the mass analyzer, yield a desired ion population size. Existing techniques facilitate automatic gain control by estimating an ion flux and then by scaling that estimated ion flux according to a linear ion trap filling function. Such existing techniques provide progressively inaccurate or incorrect results as the desired ion population size gets farther away from the estimated ion flux, which can be considered as undesirable.

Various embodiments described herein can help to ameliorate this technical problem. In particular, various embodiments described herein can leverage machine learning so as to predict a non-linear ion trap filling function (e.g., exponential growth function) that represents the true ion accumulation behavior associated with the mass analyzer. Specifically, various embodiments described herein can involve training a machine learning model to predict exponential growth coefficients based on inputted ion trap parameter configurations. Thus, for any given ion trap parameter configuration, the machine learning model can be executed so as to infer what specific exponential growth coefficients describe the ion accumulation behavior that is exhibited or caused by that given ion trap parameter configuration. So, those predicted or inferred exponential growth coefficients can be used to non-linearly scale any estimated ion flux to any desired ion population size, regardless of how far away the desired ion population size is from the estimated ion flux. In this way, various embodiments described herein can perform automatic gain control more accurately or reliably, as compared to existing techniques which blanketly assume a linear ion trap filling function regardless of ion trap operating parameter configuration.

Furthermore, it must be emphasized how counterintuitive various embodiments described herein are. Indeed, various embodiments described herein can be considered as a highly unusual, strange, creative, or unexpected application or utilization of machine learning. After all, as explained above, automatic gain control is conventionally performed by linearly scaling an estimated ion flux up to a desired ion population size. Conventional efforts directed at increasing the accuracy or reliability of automatic gain control focus myopically on improving or correcting ion flux estimation (e.g., such that linear scaling is applied to a corrected or improved ion flux estimate rather than to a raw or uncorrected ion flux estimate). Stated differently, such conventional efforts treat linear scaling as an established, immutable, or unquestionable step within automatic gain control. In stark contravention of such conventional teachings, various embodiments described herein replace linear scaling with non-linear scaling, where such non-linear scaling is performed using a non-linear function whose defining coefficients are inferred or predicted via machine learning. Thus, various embodiments described herein can be considered as a clever utilization of machine learning that is diametrically opposed to the conventional teachings in the field of automatic gain control.

For at least the above reasons, various embodiments described herein can be considered as addressing or ameliorating various technical problems or disadvantages that plague existing techniques. Therefore, various embodiments described herein can be considered as a concrete and tangible technical improvement or technical effect in the field of automatic gain control. Accordingly, various embodiments described herein certainly qualify as useful and practical applications of computers.

Furthermore, various embodiments described herein can control real-world tangible devices based on the disclosed teachings. For example, various embodiments described herein can electronically activate, deactivate, or otherwise actuate real-world hardware (e.g., ion traps) of real-world mass analyzers.

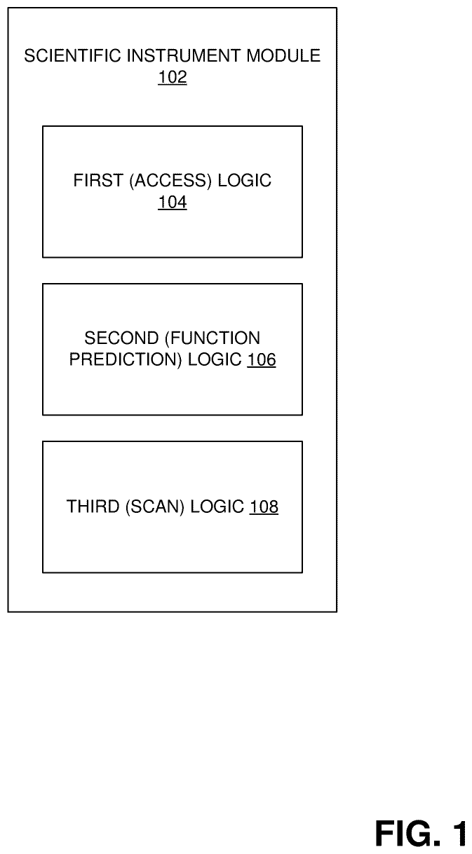

FIG. 1 illustrates an example, non-limiting block diagram of a scientific instrument module 102 in accordance with various embodiments described herein.

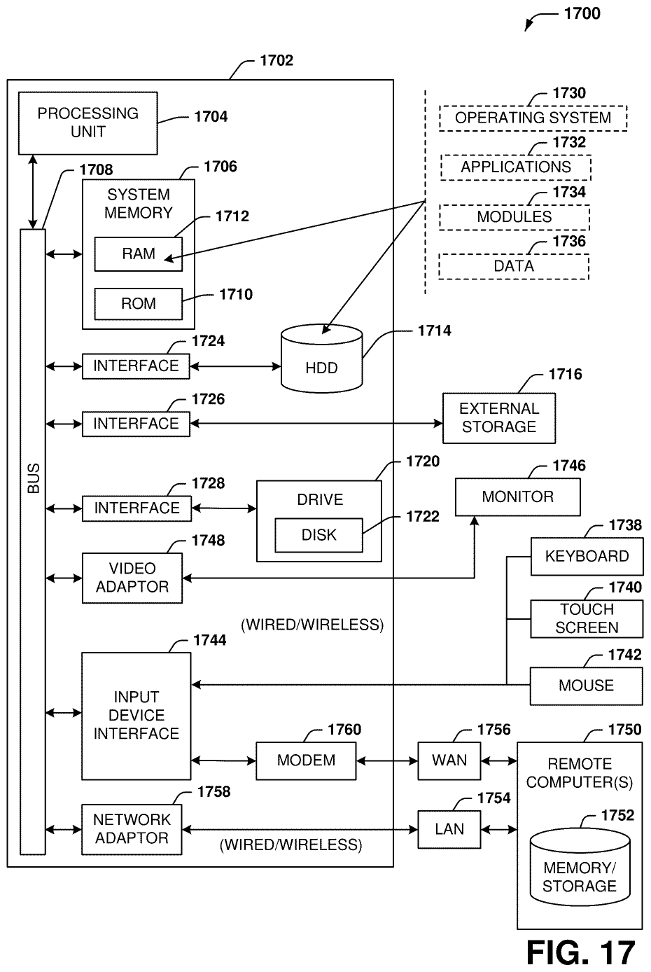

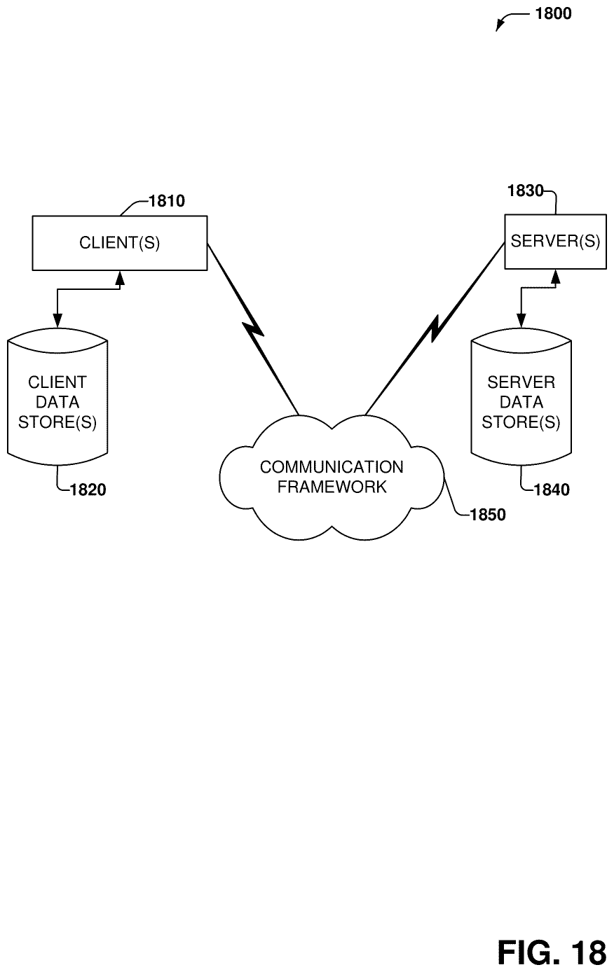

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 17, and examples of systems or networks of interconnected computing devices, in which the scientific instrument module 102 may be implemented across one or more of the computing devices, are discussed herein with reference to FIG. 18.

The scientific instrument module 102 can include first logic 104, second logic 106, or third logic 108. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of an analytical specimen (e.g., of a known or unknown mixture, compound, or collection of matter). As a non-limiting example, a scientific instrument can be a scanning electron microscope. In such case, the scientific instrument can measure or determine a surface topography of the analytical specimen. As another non-limiting example, a scientific instrument can be a transmission electron microscope. In such case, the scientific instrument can measure or determine internal structural details of the analytical specimen. As yet another non-limiting example, a scientific instrument can be an electron energy-loss microscope. In such case, the scientific instrument can measure or determine location-wise counts or intensities across a range of defined energy-loss bins or bands for the analytical specimen. As a more general non-limiting example, a scientific instrument can be any suitable type of charged-particle microscope (e.g., some types of microscopes can use beams of non-electron ions to capture images or energy spectra or to otherwise interact with specimens). As another non-limiting example, a scientific instrument can be a mass spectrometer that is operatively coupled to a chromatograph. In such case, the scientific instrument can measure or determine chromatograms (e.g., relative compound abundance as a function of retention time) or mass spectra (e.g., relative ion abundance as a function of mass-to-charge ratio) of the analytical sample. In any of such situations, the scientific instrument can include or otherwise contain a mass analyzer.

In various embodiments, the first logic 104 can involve accessing or otherwise establishing electronic communication with the mass analyzer.

In various embodiments, the second logic 106 can involve predicting, via a machine learning model, an ion trap filling function based on a current operational parameter configuration of the mass analyzer. In particular, the ion trap filling function can be a mathematical function that takes as input a real-valued scalar representing ion population size, and that produces as output a real-valued scalar representing ion injection time. In various aspects, the ion trap filling function can be defined by various scalar coefficients that can be added to, subtracted from, multiplied by, divided by, serve as an exponent of, raised to the power of, or otherwise mathematically applied to the inputted ion population size so as to produce, compute, or calculate the outputted ion injection time. In any case, the machine learning model can be considered as predicting or inferring specific values of those scalar coefficients, where those specific values cause the ion trap filling function to accurately or reliably represent the true or real-world (e.g., non-linear) temporal ion accumulation behavior exhibited by the mass analyzer. In other words, the machine learning model can be considered as identifying which specific values of those scalar coefficients cause the ion trap filling function to correctly map ion population sizes to the ion injection times needed by the mass analyzer to achieve those ion population sizes.

In various embodiments, the third logic 108 can involve causing the mass analyzer to perform a scan using an ion injection time that is correlated to a requested ion population size by the ion trap filling function. In some cases, the ion injection time used during the scan can be equal to the result obtained by feeding the requested ion population size as input to the ion trap filling function. In other cases, the ion injection time used during the scan can be equal to a flux ion injection time that is scaled using the ion trap filling function.

Accordingly, the scientific instrument module 102 can facilitate machine learning prediction of ion trap filling functions.

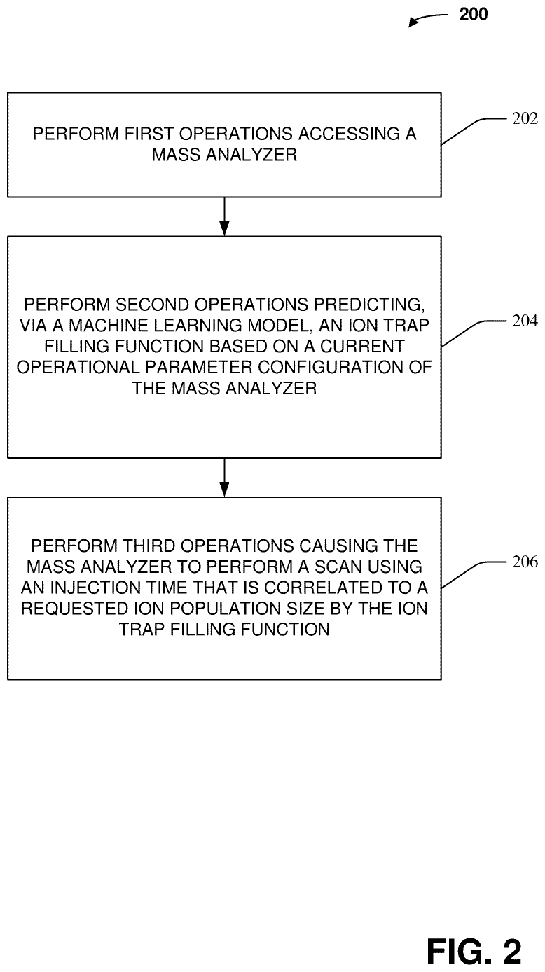

FIG. 2 is an example, non-limiting flow diagram of a computer-implemented method 200 in accordance with various embodiments described herein. The operations of the computer-implemented method 200 may be used in any suitable context to perform any suitable operations (e.g., can be performed by or used in conjunction with any of the various modules, computing devices, or graphical user interfaces described with respect to of FIGS. 1, 17, and 18). Operations are illustrated once each and in a particular order in FIG. 2, but the operations may be reordered or repeated as desired and appropriate (e.g., different operations performed may be performed in parallel, as suitable).

In various aspects, act 202 can include performing first operations accessing a mass analyzer. In various cases, the first logic 104 can perform or otherwise facilitate act 202.

In various aspects, act 204 can include performing second operations predicting, via a machine learning model, an ion trap filling function based on a current operational parameter configuration of the mass analyzer. In various instances, the second logic 106 can perform or otherwise facilitate act 204.

In various aspects, act 206 can include performing third operations causing the mass analyzer to perform a scan using an injection time that is correlated to a requested ion population size by the ion trap filling function.

Accordingly, the computer-implemented method 200 can facilitate machine learning prediction of ion trap filling functions.

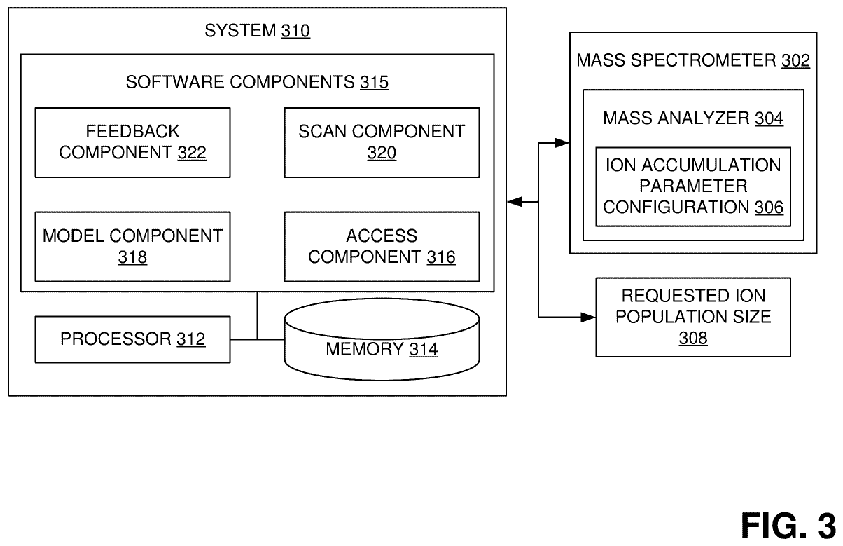

FIG. 3 illustrates a block diagram of an example, non-limiting system that can facilitate machine learning prediction of ion trap filling functions in accordance with one or more embodiments described herein.

In various embodiments, there can be a mass spectrometer 302. In various aspects, the mass spectrometer 302 can be any suitable type of mass spectrometer exhibiting any suitable design or construction for measuring mass spectra of analytical samples. In various instances, the mass spectrometer 302 can be made up of any suitable constituent hardware. As a non-limiting example, the mass spectrometer 302 can include any suitable ion source or ion beam emitter, such as a matrix assisted laser desorption/ionization (MALDI) source, electrospray ionization (ESI) source, atmospheric pressure chemical ionization (APCI) source, atmospheric pressure photoionization (APPI) source, or inductively coupled plasma (ICP) source. As another non-limiting example, the mass spectrometer 302 can include any suitable ion detectors, such as electron multiplier detectors, microchannel plate detectors, image charge detectors, or Faraday cup detectors. As even another non-limiting example, the mass spectrometer 302 can include any suitable ion optics equipment, such as ion focusing lenses, ion guides, or ion deflectors. In some instances, the mass spectrometer 302 can be any suitable type of Fourier transform mass spectrometer.

In various cases, one of the pieces of constituent hardware that make up the mass spectrometer 302 can be a mass analyzer 304. In various aspects, the mass analyzer 304 can exhibit any suitable design or construction that can physically separate (or, in some instances, otherwise distinguish without physically separating) ions according to their mass-to-charge ratios. As a non-limiting example, the mass analyzer 304 can be any suitable type of quadrupole filter mass analyzer. As another non-limiting example, the mass analyzer 304 can be any suitable type of time-of-flight mass analyzer. As yet another non-limiting example, the mass analyzer 304 can be any suitable type of orbital trapping mass analyzer. As still another non-limiting example, the mass analyzer 304 can be any suitable type of Fourier transform ion cyclotron resonance mass analyzer. As even another non-limiting example, the mass analyzer 304 can be any suitable type of magnetic sector mass analyzer.

Depending upon its specific design or construction, the mass analyzer 304 can be considered as having, being equipped with, or otherwise being associated with any suitable type of ion trap from which the mass analyzer 304 can physically receive trapped ions. As a non-limiting example, the mass analyzer 304 can have, be physically equipped or outfitted with, be physically integrated with, or be physically downstream of a quadrupole ion trap. As another non-limiting example, the mass analyzer 304 can have, be physically equipped or outfitted with, be physically integrated with, or be physically downstream of a linear ion trap. As yet another non-limiting example, the mass analyzer 304 can have, be physically equipped or outfitted with, be physically integrated with, or be physically downstream of a curved (e.g., C-) ion trap. As still another non-limiting example, the mass analyzer 304 can have, be physically equipped or outfitted with, be physically integrated with, or be physically downstream of a SLIM (structures for lossless ion manipulations) device or any suitable ion trap array.

No matter the specific type of such ion trap, that ion trap can have any suitable number of any suitable types of configurable ion accumulation parameters. In various aspects, a configurable ion accumulation parameter can be any suitable hardware-related characteristic or software-related characteristic of the ion trap of the mass analyzer 304 that can guide, affect, or otherwise dictate how the ion trap physically traps, accumulates, gathers, houses, or collects ions and that can be selectively controlled, changed, adjusted, or otherwise set (e.g., by a user of the mass spectrometer 302 or automatically).

In some cases, such configurable ion accumulation parameters can include one or more parameters representing or otherwise related to a scan range of the mass analyzer 304. Indeed, the scan range of the mass analyzer 304 can be considered as the range or interval of mass-to-charge ratios over which the mass analyzer 304 is configured to detect ions during a scan. Any ion whose mass-to-charge ratio falls within the scan range can be considered as being detectable, isolatable, separatable, or otherwise measurable by the mass analyzer 304 (e.g., such ions can be represented or captured in whatever resultant spectral data is produced by the mass spectrometer 302). Conversely, any ion whose mass-to-charge ratio falls outside the scan range can instead be considered as not being detectable, isolatable, separatable, or otherwise measurable by the mass analyzer 304 (e.g., such ions can fail to be represented or captured in whatever resultant spectral data is produced by the mass spectrometer 302). As a non-limiting example, the configurable ion accumulation parameters can include a scan-range lower-bound parameter and a scan-range upper-bound parameter. In various aspects, the scan-range lower-bound parameter can be considered as a real-valued scalar variable whose magnitude indicates the bottom, lowest, least, or initial mass-to-charge ratio within the scan range. In various instances, the scan-range upper-bound parameter can be considered as a real-valued scalar variable whose magnitude indicates the top, highest, greatest, or final mass-to-charge ratio in the scan range. As another non-limiting example, the configurable ion accumulation parameters can include a scan-range midpoint parameter and a scan-range width parameter. In various aspects, the scan-range midpoint parameter can be considered as a real-valued scalar variable whose magnitude indicates the median, middle, or central mass-to-charge ratio in the scan range. In various instances, the scan-range width parameter can be considered as a real-valued scalar variable whose magnitude indicates the difference between the highest and lowest mass-to-charge ratios within the scan range. In any of such cases, selectively changing (e.g., increasing or decreasing) the scan-range lower-bound parameter, the scan-range upper-bound parameter, the scan-range midpoint parameter, or the scan-range width parameter can commensurately change (e.g., widen, narrow, or shift) the scan range implemented by the mass analyzer 304.

In some aspects, the configurable ion accumulation parameters can include one or more parameters representing or otherwise related to a pass range of the ion trap associated with the mass analyzer 304. Indeed, the pass range of the ion trap can be considered as the range or interval of mass-to-charge ratios which the ion trap is configured to accumulate, house, collect, gather, or retain. Any ion whose mass-to-charge ratio falls within the pass range can be considered as being accumulatable or trappable by the ion trap (e.g., such ions can be subsequently separated by the mass analyzer and thus represented or captured in whatever resultant spectral data is produced by the mass spectrometer 302). Conversely, any ion whose mass-to-charge ratio falls outside the pass range can instead be considered as not being accumulatable or trappable by ion trap (e.g., such ions can fail to be subsequently separated by the mass analyzer and thus cannot be represented or captured in whatever resultant spectral data is produced by the mass spectrometer 302). As a non-limiting example, the configurable ion accumulation parameters can include a pass-range lower-bound parameter and a pass-range upper-bound parameter. In various aspects, the pass-range lower-bound parameter can be considered as a real-valued scalar variable whose magnitude indicates the bottom, lowest, least, or initial mass-to-charge ratio within the pass range. In various instances, the pass-range upper-bound parameter can be considered as a real-valued scalar variable whose magnitude indicates the top, highest, greatest, or final mass-to-charge ratio in the pass range. As another non-limiting example, the configurable ion accumulation parameters can include a pass-range midpoint parameter and a pass-range width parameter. In various aspects, the pass-range midpoint parameter can be considered as a real-valued scalar variable whose magnitude indicates the median, middle, or central mass-to-charge ratio in the pass range. In various instances, the pass-range width parameter (sometimes referred to as an isolation width parameter) can be considered as a real-valued scalar variable whose magnitude indicates the difference between the highest and lowest mass-to-charge ratios within the pass range. In any of such cases, selectively changing (e.g., increasing or decreasing) the pass-range lower-bound parameter, the pass-range upper-bound parameter, the pass-range midpoint parameter, or the pass-range width parameter can commensurately change (e.g., widen, narrow, or shift) the pass range implemented by the ion trap.

In some aspects, the configurable ion accumulation parameters can include one or more parameters representing or otherwise related to stacked ring ion guide (SRIG) injections associated with the mass spectrometer 302. Indeed, an SRIG can be considered as an S-lens or funnel radio-frequency (RF) ion guide that is physically located or positioned at an inlet of the mass spectrometer 302. The SRIG can serve to refocus ions as those ions travel from atmospheric pressure outside of the mass spectrometer 302 to lower or vacuum pressures within the mass spectrometer 302. In various aspects, SRIG injections can be considered as multiple, serial injections of ions at different or respective RF levels through the SRIG (and therefore at different or respective m/z intervals), which ions are then stored together in the ion trap associated with the mass analyzer 304. In other words, the SRIG can be physically located upstream of the ion trap, and the SRIG injections can be considered as filling or populating the ion trap. In various instances, the greater the number of SRIG injections that are implemented, the more diversity in terms of m/z distribution can be exhibited by the ions that are stored or trapped in the ion trap (e.g., full scans, or any other scans that span or cover a wide m/z range, can be performed via a larger number of SRIG injections). Conversely, the lower the number of SRIG injections that are implemented, the less diversity in terms of m/z distribution can be exhibited by the ions that are stored or trapped in the ion trap (e.g., selective scans, or any other scans that span or cover a narrow m/z range, can be performed via a lower number of SRIG injections). As a non-limiting example, the configurable ion accumulation parameters can include an SRIG injection count parameter. In various aspects, the SRIG injection count parameter can be considered as an integer-valued scalar variable whose magnitude indicates how many SRIG injections (e.g., each at a respective RF level) are implemented or employed by the mass spectrometer 302 during any given scan.

It should be understood or otherwise appreciated that the mass analyzer 304 can have or otherwise be associated with any other suitable types of configurable ion accumulation parameters.

In any case, whatever specific values or states are currently or presently assigned to the configurable ion accumulation parameters of the mass analyzer 304 can be collectively referred to as an ion accumulation parameter configuration 306. As a non-limiting example, the ion accumulation parameter configuration 306 can be one or more scalars, one or more vectors, one or more matrices, one or more tensors, one or more character strings, or any suitable combination thereof that can indicate, represent, or otherwise convey: what specific value is currently or presently assigned to the scan-range lower-bound parameter of the mass analyzer 304; what specific value is currently or presently assigned to the scan-range upper-bound parameter of the mass analyzer 304; what specific value is currently or presently assigned to the scan-range midpoint parameter of the mass analyzer 304; what specific value is currently or presently assigned to the scan-range width parameter of the mass analyzer 304; what specific value is currently or presently assigned to the pass-range lower-bound parameter of the ion trap; what specific value is currently or presently assigned to the pass-range upper-bound parameter of the ion trap; what specific value is currently or presently assigned to the pass-range midpoint parameter of the ion trap; what specific value is currently or presently assigned to the pass-range width parameter of the ion trap; or what specific value is currently or presently assigned to the SRIG injection count parameter of the mass spectrometer 302.

In various aspects, there can be a requested ion population size 308. In various instances, the requested ion population size 308 can be an integer-valued scalar whose magnitude indicates how many ions are desired to be accumulated within the ion trap of the mass analyzer 304 during some subsequent or upcoming scan. In various cases, the requested ion population size 308 can be electronically provided, selected, or otherwise identified by a user or technician of the mass spectrometer 302, such as by physically interacting with a graphical user interface (e.g., touchscreen, keyboard, mousepad) of the mass spectrometer 302. In order for such subsequent or upcoming scan to be performed, it must be determined what ion injection time would cause the ion trap of the mass analyzer 304 to accumulate the requested ion population size 308. As described herein, a system 310 can facilitate such determination and scan.

Note that the system 310 can, in some cases, be implemented on or hosted by the mass spectrometer 302 itself or any suitable computerized workstation that is associated with or coupled to the mass spectrometer 302. In such situations, the system 310 can be considered as being deployed in a client-side fashion (e.g., the system 310 can be considered as being local to the mass spectrometer 302). However, in other cases, the system 310 can instead be implemented or hosted remotely from the mass spectrometer 302, such as in a cloud computing environment. In such situations, the system 310 can be considered as being deployed in a server-side fashion.

In various aspects, the system 310 can comprise a processor 312 (e.g., computer processing unit, microprocessor) and a non-transitory computer-readable memory 314 that is operably or operatively or communicatively connected or coupled to the processor 312. The non-transitory computer-readable memory 314 can store computer-executable instructions which, upon execution by the processor 312, can cause the processor 312 or other components of the system 310 (e.g., access component 316, model component 318, scan component 320, feedback component 322) to perform one or more acts. In various embodiments, the non-transitory computer-readable memory 314 can store computer-executable components (e.g., access component 316, model component 318, scan component 320, feedback component 322), and the processor 312 can execute the computer-executable components.

In various embodiments, the system 310 can include an access component 316. In various aspects, the access component 316 can electronically access the mass spectrometer 302 and thus the mass analyzer 304. That is, the access component 316 can electronically communicate or otherwise electronically interact with (e.g., transmit electronic instructions or commands to; receive electronic data from) the mass spectrometer 302 in any suitable fashion. Accordingly, the access component 316 can act as a proxy or conduit through which any other components of the system 310 can interact with, communicate with, activate, deactivate, or otherwise manipulate the mass spectrometer 302 or the mass analyzer 304. Because of such electronic communication, the access component 316 can electronically receive, electronically retrieve, or otherwise electronically obtain the ion accumulation parameter configuration 306 or the requested ion population size 308. Thus, any other component of the system 310 can interact with or otherwise utilize the ion accumulation parameter configuration 306 or the requested ion population size 308.

In various embodiments, the system 310 can include a model component 318. In various aspects, the model component 318 can, as described herein, predict or infer, via execution of a machine learning model, coefficients for an ion trap filling function, based on the ion accumulation parameter configuration 306.

In various embodiments, the system 310 can include a scan component 320. In various instances, the scan component 320 can, as described herein, identify an ion injection time that is correlated to the requested ion population size 308 by the predicted coefficients of the ion trap filling function, and the scan component 320 can further cause the mass spectrometer 302 to perform a scan utilizing that identified ion injection time.

In various embodiments, the system 310 can include a feedback component 322. In various cases, the feedback component 322 can, as described herein, perform a real-time update on the machine learning model, based on a measured ion population size that is achieved by the identified ion injection time.

Note that, in various instances, the access component 316, the model component 318, the scan component 320, and the feedback component 322 can collectively be considered as being one or more software components 315 of the system 310. In various aspects, it should be appreciated that the one or more software components 315 are described primarily herein as comprising four components (e.g., the access component 316, the model component 318, the scan component 320, and the feedback component 322) for ease of explanation and illustration. However, the one or more software components 315 are not limited to being implemented as exactly such four components in every embodiment. Indeed, in some embodiments, the functionalities described herein of such four components can be combined in any suitable fashions, so as to be implemented in or by fewer than four components (e.g., in some cases, a single component can perform all of the functionalities that are described herein with respect to the access component 316, the model component 318, the scan component 320, and the feedback component 322). In other embodiments, the functionalities described herein of such four components can instead be distributed, separated, split, or fragmented in any suitable fashions, so as to be implemented in or by more than four components (e.g., two or more components can facilitate the functionalities that are performable by the access component 316; two or more components can facilitate the functionalities that are performable by the model component 318; two or more components can facilitate the functionalities that are performable by the scan component 320; two or more components can facilitate the functionalities that are performable by the feedback component 322).

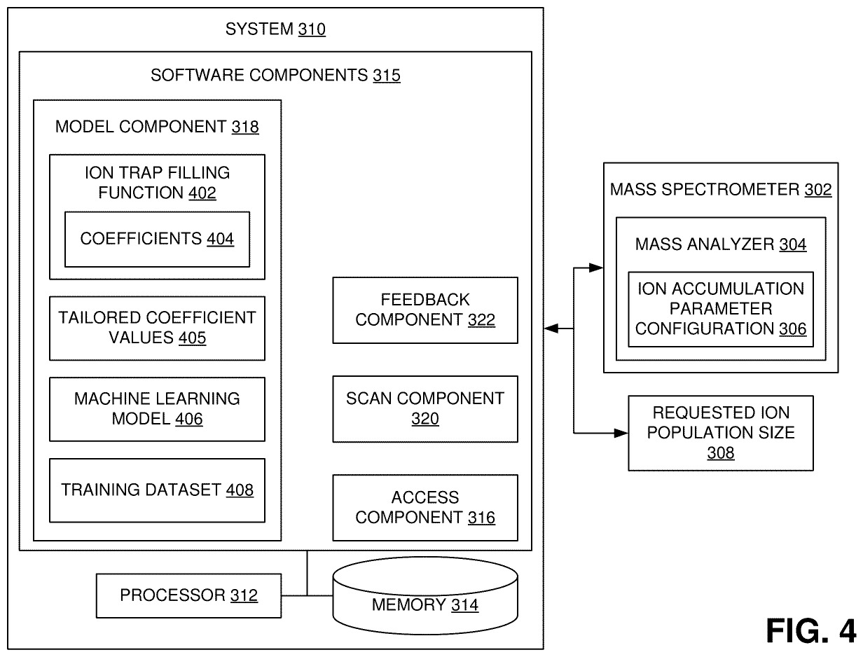

FIG. 4 illustrates a block diagram of an example, non-limiting system including an ion trap filling function made up of a set of coefficients, a set of tailored coefficient values, a machine learning model, and a training dataset that can facilitate machine learning prediction of ion trap filling functions in accordance with one or more embodiments described herein.

In various embodiments, the model component 318 can electronically store, electronically maintain, electronically control, or otherwise electronically access an ion trap filling function 402. In various aspects, the ion trap filling function 402 can be any suitable mathematical function or composition of mathematical functions that are intended to model, forecast, or otherwise represent the transient ion accumulation behavior of the ion trap of the mass analyzer 304. In other words, the ion trap filling function 402 can be any suitable combination of mathematical operators (e.g., addition operators, subtraction operators, multiplication operators, division operators, root operators, power operators, exponential operators, logarithmic operators, trigonometric operators, rounding operators, derivative operators, integral operators) which can convert an input argument into an output argument. In various instances, the input argument of the ion trap filling function 402 can be a real-valued scalar representing ion population size. In various cases, the output argument of the ion trap filling function 402 can be a real-valued scalar representing ion injection time. That is, the ion trap filling function 402 can mathematically transform or convert an inputted ion population size into an outputted ion injection time, and such transformation or conversion can be interpreted to mean that implementation of the outputted ion injection time by an ion trap of a mass analyzer will or would achieve the inputted ion population size. In various aspects, the ion trap filling function 402 can be non-linear.

Regardless of the specific structure or format of the ion trap filling function 402, it can be made up of or otherwise defined by a set of coefficients 404. In various instances, the set of coefficients 404 can include any suitable number of coefficients, each of which can be a considered as a real-valued scalar variable. In various cases, the ion trap filling function 402 can be considered as computing the outputted ion injection time by mathematically combining in any suitable fashion the inputted ion population size with the set of coefficients 404. As a non-limiting example, any of the set of coefficients 404 can be considered as a constant that is added to, subtracted from, multiplied by, or divided by the inputted ion population size. As another non-limiting example, any of the set of coefficients 404 can be considered as a power or root to which the inputted ion population size is raised. As even another non-limiting example, any of the set of coefficients 404 can be considered as a base whose exponent is some function of the inputted ion population size.

As a non-limiting illustration, suppose the ion trap filling function 402 is given by the following exponential growth function:

$$f ( p ) = a + {be}^{\frac{p}{c}}$$

In such case, p can represent an inputted ion population size, ƒ(p) can represent an outputted ion injection time that would achieve an ion population size of p, and a, b, and c can be considered as the set of coefficients 404 (e.g., can be considered as three real-valued scalars that the ion trap filling function 402 utilizes to mathematically convert or transform p into ƒ(p)).

In various aspects, the model component 318 can electronically identify or otherwise electronically determine a set of tailored coefficient values 405 that respectively correspond (e.g., in one-to-one fashion) to the set of coefficients 404. In various instances, each of the set of tailored coefficient values 405 can be a specific scalar value which can be assigned to or otherwise taken by a respective one of the set of coefficients 404. In various cases, the set of tailored coefficient values 405 can be whatever specific values which, when assigned to or otherwise taken by the set of coefficients 404, cause the ion trap filling function 402 to properly, accurately, correctly, or otherwise reliably describe or represent the real-world ion accumulation behavior that is actually or truly exhibited by the mass analyzer 304. To continue the above non-limiting illustration where the ion trap filling function 402 is given by

$$f ( p ) = a + {be}^{\frac{p}{c}} ,$$

the set of tailored coefficient values 405 can be three particular, fixed scalar values which, when respectively assigned to or taken by the coefficients a, b, and c, cause the ion trap filling function 402 to accurately or correctly output what ion injection times ƒ(p) would, if implemented by the mass analyzer 304, actually or truly achieve what inputted ion population sizes p.

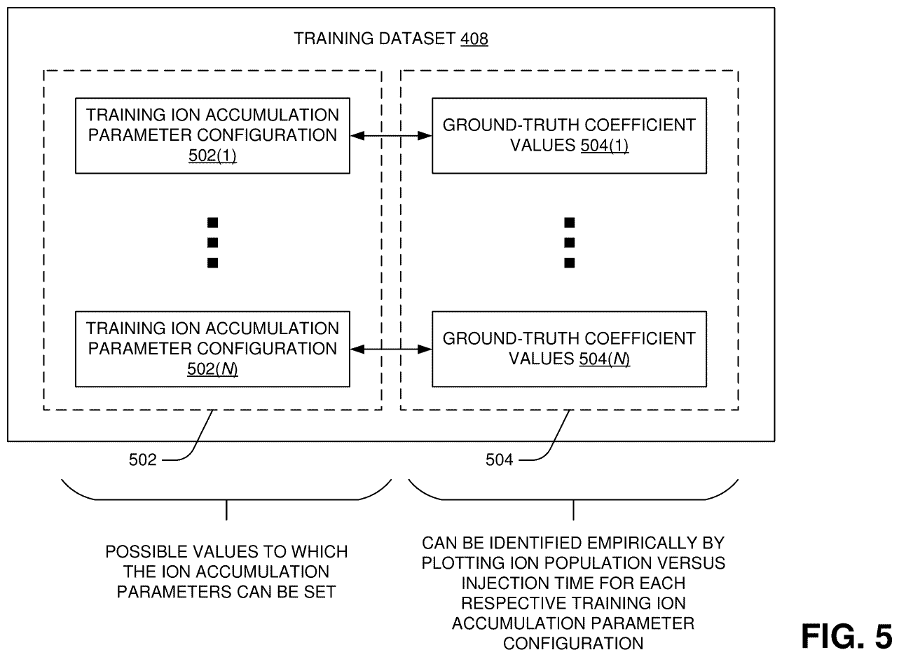

In various embodiments, the model component 318 can electronically identify or determine the set of tailored coefficient values 405, by leveraging a machine learning model 406 that is or has been trained on a training dataset 408. Various non-limiting aspects are described with respect to FIGS. 5-8.

FIGS. 5-8 illustrate example, non-limiting block diagrams showing how the set of tailored coefficient values 405 for the ion trap filling function can be obtained in accordance with one or more embodiments described herein.

First, consider FIG. 5, which illustrates a non-limiting example embodiment of the training dataset 408.

In various embodiments, the training dataset 408 can include or be made up of a plurality of training ion accumulation parameter configurations 502. In various aspects, the plurality of training ion accumulation parameter configurations 502 can contain a total of n configurations, for any suitable positive integer n>1: a training ion accumulation parameter configuration 502(1) to a training ion accumulation parameter configuration 502(n). In various instances, each of the plurality of training ion accumulation parameter configurations 502 can be a unique or distinct collection of values or states which can possibly or potentially be assigned to or taken by the configurable ion accumulation parameters of the mass analyzer 304. Thus, each of the plurality of training ion accumulation parameter configurations 502 can exhibit the same format, size, or dimensionality as the ion accumulation parameter configuration 306. As a non-limiting example, suppose that the configurable ion accumulation parameters of the mass analyzer 304 include a scan-range lower-bound parameter, a scan-range upper-bound parameter, and a pass-range midpoint parameter. In such situation, the training ion accumulation parameter configuration 502(1) can be considered as a first unique or distinct lower-bound-upper-bound-midpoint tuple that can possibly or potentially be assigned to the scan-range lower-bound parameter, the scan-range upper-bound parameter, and the pass-range midpoint parameter. Likewise, in such situation, the training ion accumulation parameter configuration 502(n) can be considered as an n-th unique or distinct lower-bound-upper-bound-midpoint tuple that can possibly or potentially be assigned to the scan-range lower-bound parameter, the scan-range upper-bound parameter, and the pass-range midpoint parameter.

In various aspects, the training dataset 408 can include or be made up of a plurality of sets of ground-truth coefficient values 504. In various instances, the plurality of sets of ground-truth coefficient values 504 can respectively correspond (e.g., in one-to-one fashion) to the plurality of training ion accumulation parameter configurations 502. Accordingly, since the plurality of training ion accumulation parameter configurations 502 can include a total of n configurations, the plurality of sets of ground-truth coefficient values 504 can include a total of n sets: a set of ground-truth coefficient values 504(1) to a set of ground-truth coefficient values 504(n). In various cases, each of the plurality of sets of ground-truth coefficient values 504 can be a collection of specific scalar values which, if respectively assigned to the set of coefficients 404, are known or deemed to cause the ion trap filling function to correctly or accurately represent the ion accumulation behavior of the mass analyzer 304 when the mass analyzer 304 operates according to a respective one of the plurality of training ion accumulation parameter configurations 502.

As a non-limiting example, the set of ground-truth coefficient values 504(1) can correspond to the training ion accumulation parameter configuration 502(1). Thus, the set of ground-truth coefficient values 504(1) can be considered as the specific or particular values of the set of coefficients 404 which would cause the ion trap filling function 402 to correctly or accurately represent or model the ion accumulation behavior of the mass analyzer 304, when the configurable ion accumulation parameters of the mass analyzer 304 have whatever specific values or states are specified by the training ion accumulation parameter configuration 502(1).

As another non-limiting example, the set of ground-truth coefficient values 504(n) can correspond to the training ion accumulation parameter configuration 502(n). So, the set of ground-truth coefficient values 504(n) can be considered as the specific or particular values of the set of coefficients 404 which would cause the ion trap filling function 402 to correctly or accurately represent or model the ion accumulation behavior of the mass analyzer 304, when the configurable ion accumulation parameters of the mass analyzer 304 have whatever specific values or states are specified by the training ion accumulation parameter configuration 502(n).

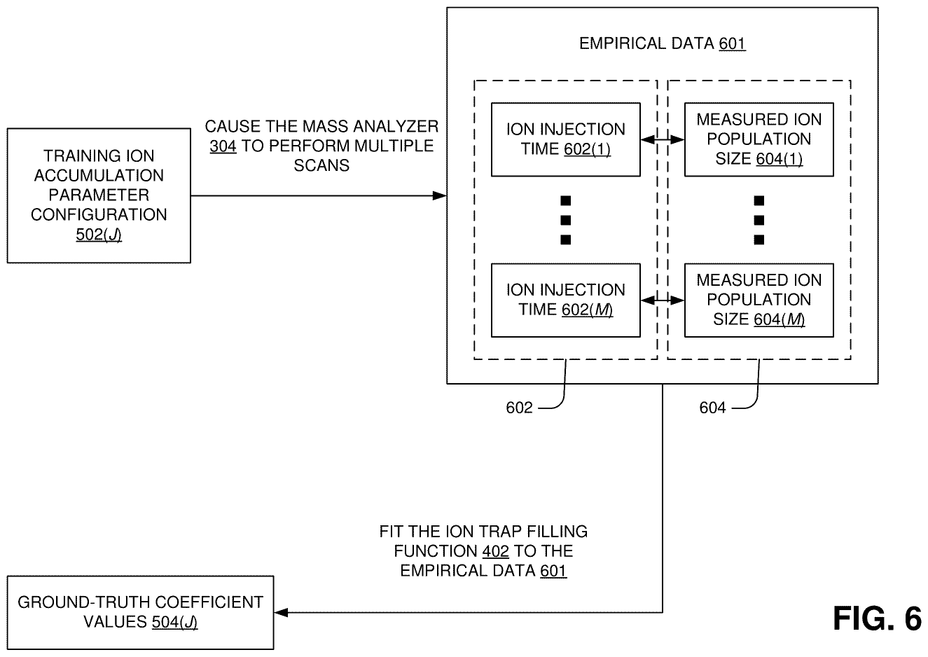

In various cases, the plurality of sets of ground-truth coefficient values 504 can be identified empirically. In particular, ion population size versus ion injection time can be plotted for each of the plurality of training ion accumulation parameter configurations 502, and such plots can each yield or otherwise lead to the plurality of sets of ground-truth coefficient values 504. This is shown in more detail with respect to FIG. 6.

As shown in FIG. 6, the model component 318 can select any one of the plurality of training ion accumulation parameter configurations 502. Such selected configuration can be referred to as a training ion accumulation parameter configuration 502(j), for any suitable positive integer j≤n. In various aspects, the model component 318 can cause the mass analyzer 304 to perform multiple scans (e.g., on any suitable sample, or on no sample at all) using the training ion accumulation parameter configuration 502(j). In other words, the model component 318 can electronically instruct, electronically command, or otherwise electronically cause the mass analyzer 304 to run, in sequential order, multiple scans while the configurable ion accumulation parameters of the mass analyzer 304 are set or configured to whatever specific values or states are specified in the training ion accumulation parameter configuration 502(j). For ease of illustration and explanation, suppose that the model component 318 causes the mass analyzer 304 to perform in series a total of p scans using the training ion accumulation parameter configuration 502(j), for any suitable positive integer p>1.

In various aspects, the mass analyzer 304 can electronically generate or otherwise electronically record empirical data 601 as a result of those p scans. Specifically, each of those p scans can be performed according to a unique, distinct, or respective ion injection time, and the mass spectrometer 302 can measure how many ions are or were accumulated in the ion trap associated with the mass analyzer 304 as a result of that unique, distinct, or respective ion injection time. It should be appreciated that such measurement can be facilitated in any suitable fashion (e.g., via ion signal detection, via resonance excitation and ejection, via ion decay monitoring, via ion fragmentation and charge detection, via statistical estimation). In any case, the empirical data 601 can thus include a plurality of ion injection times 602 and a plurality of measured ion population sizes 604, both of which can respectively correspond (e.g., in one-to-one fashion) to those p scans. Specifically, the plurality of ion injection times 602 can include a total of p times: an ion injection time 602(1) to an ion injection time 602(p). Likewise, the plurality of measured ion population sizes 604 can include a total of p sizes: a measured ion population size 604(1) to a measured ion population size 604(p). In various instances, each of the plurality of ion injection times 602 can be the specific ion injection time that was used in a respective one of those p scans, and each of the plurality of measured ion population sizes 604 can be an ion population size that was achieved in the ion trap during a respective one of those p scans. As a non-limiting example, the ion injection time 602(1) can be a scalar indicating what injection time was used during the first scan, and the measured ion population size 604(1) can be the number of ions that the ion injection time 602(1) caused to accumulate in the ion trap during that first scan. As another non-limiting example, the ion injection time 602(p) can be a scalar indicating what injection time was used during the p-th scan, and the measured ion population size 604(p) can be the number of ions that the ion injection time 602(p) caused to accumulate in the ion trap during that p-th scan. In other words, the empirical data 601 can be considered as a collection of p tuples, with each tuple indicating a respective ion injection time and resultant ion population size.

Note how the empirical data 601 can be formatted as a plot whose abscissa axis represents ion population size and whose ordinate axis represents ion injection time. In various aspects, the model component 318 can electronically fit the ion trap filling function 402 to such plot using any suitable curve fitting technique (e.g., least sum of squares). In various instances, such fitting can yield or produce a set of ground-truth coefficient values 504(j), which can be considered as whichever one of the plurality of sets of ground-truth coefficient values 504 that corresponds to the training ion accumulation parameter configuration 502(j). Stated differently, the act of fitting the ion trap filling function 402 to the empirical data 601 can be considered as iteratively computing or identifying what specific values of the set of coefficients 404 cause an error (e.g., mean squared error) between the ion trap filling function 402 and the empirical data 601 to become minimized, and such computed or identified values of the set of coefficients 404 can be referred to as the set of ground-truth coefficient values 504(j).

In various aspects, the model component 318 can repeat various of the above-described actions for each of the plurality of training ion accumulation parameter configurations 502, and such repetition can ultimately yield the plurality of sets of ground-truth coefficient values 504.

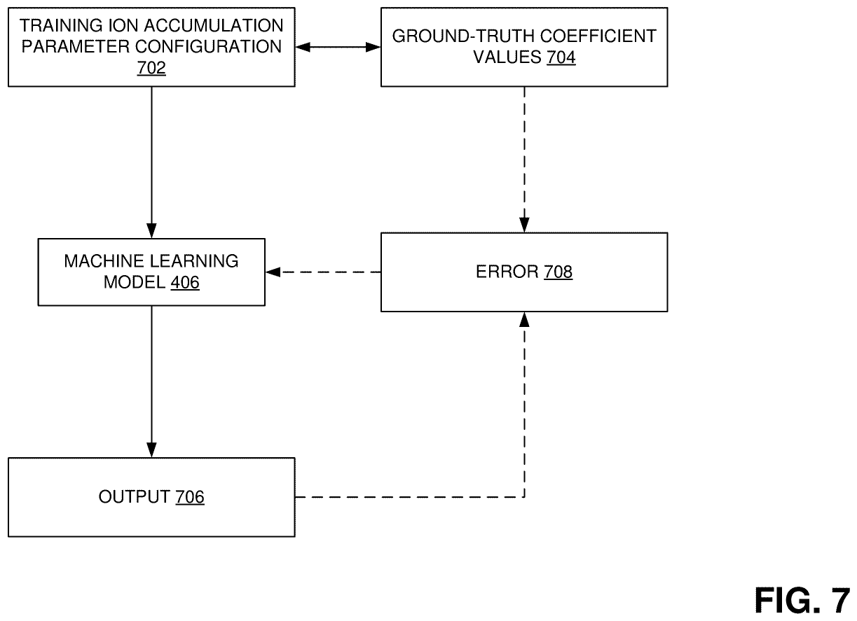

Next, consider FIG. 7. In various embodiments, the model component 318 can electronically store, electronically maintain, electronically control, or otherwise electronically access the machine learning model 406. In various embodiments, the machine learning model 406 can exhibit any suitable type of artificial intelligence internal architecture. As a non-limiting example, the machine learning model 406 can exhibit any suitable deep learning neural network internal architecture. Indeed, in various cases, the machine learning model 406 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers. However, in other non-limiting examples, the machine learning model 406 can exhibit any suitable non-neural-network internal architecture, such as a decision tree internal architecture, a random forest regressor internal architecture, a naïve Bayes internal architecture, or a logistic regression internal architecture.

Regardless of the specific internal architecture (e.g., the specific numbers, types, or organizations of layers) that is implemented within the machine learning model 406, the model component 318 can electronically train, in supervised fashion on the training dataset 408, the machine learning model 406 to function or operate as a regressor that predicts values of the set of coefficients 404 in response to inputted ion accumulation parameter configurations.

Specifically, prior to beginning such training, the model component 318 can initialize in any suitable fashion (e.g., random initialization) the trainable internal parameters (e.g., convolutional kernels, weight matrices, bias values) of the machine learning model 406.

In various instances, the model component 318 can select any suitable training ion accumulation parameter configuration and corresponding set of ground-truth coefficient values from the training dataset 408. These can respectively be referred to as a training ion accumulation parameter configuration 702 and a set of ground-truth coefficients 704. In various cases, the model component 318 can execute the machine learning model 406 on the training ion accumulation parameter configuration 702, thereby causing the machine learning model 406 to produce an output 706. More specifically, suppose that the machine learning model 406 exhibits a deep learning neural network internal architecture. In such situation, the model component 318 can electronically feed the training ion accumulation parameter configuration 702 to an input layer of the machine learning model 406. In various aspects, the training ion accumulation parameter configuration 702 can complete a forward pass through one or more hidden layers of the machine learning model 406. In various instances, an output layer of the machine learning model 406 can compute or calculate the output 706, based on whatever hidden activation maps or hidden feature maps are produced by the one or more hidden layers during the forward pass.

Note that the format, size, or dimensionality of the output 706 can be dictated by the number, arrangement, sizes, or other characteristics of the neurons, convolutional kernels, attention blocks, or other internal parameters of the output layer (or of any other layers) of the machine learning model 406. Accordingly, the output 706 can be forced to have any desired format, size, or dimensionality, by adding, removing, or otherwise adjusting characteristics of the output layer (or of any other layers) of the machine learning model 406. In particular, the output 706 can be forced to have the same format, size, or dimensionality as the set of ground-truth coefficient values 704. Accordingly, the output 706 can be considered as the predicted or inferred scalar values which, if assigned to respective ones of the set of coefficients 404, the machine learning model 406 believes would cause the ion trap filling function 402 to accurately or reliably represent the ion accumulation behavior of the mass analyzer 304, when the mass analyzer 304 operates or functions according to the training ion accumulation parameter configuration 702. In contrast, the set of ground-truth coefficient values 704 can be considered as the particular scalar values which, if assigned to respective ones of the set of coefficients 404, are known or deemed to cause the ion trap filling function 402 to accurately or reliably represent the ion accumulation behavior of the mass analyzer 304, when the mass analyzer 304 operates or functions according to the training ion accumulation parameter configuration 702. Note that, if the machine learning model 406 has so far undergone no or little training, then the output 706 can be highly inaccurate. In other words, the output 706 can be very different from the set of ground-truth coefficient values 704.

In various aspects, the model component 318 can compute an error 708 (e.g., mean absolute error (MAE), mean squared error (MSE), cross-entropy error) between the output 706 and the set of ground-truth coefficient values 704. In various instances, the model component 318 can incrementally update the trainable internal parameters of the machine learning model 406 via backpropagation (e.g., stochastic gradient descent) that is driven by the error 708.

In various cases, the model component 318 can repeat such execution-and-update procedure for any suitable number of training ion accumulation parameter configurations (e.g., for each of the plurality of training ion accumulation parameter configurations 502). This can ultimately cause the trainable internal parameters of the machine learning model 406 to become iteratively optimized for accurately inferring scalar values of the set of coefficients 404 based on inputted configurations of the configurable ion accumulation parameters of the mass analyzer 304. In various aspects, any suitable training batch sizes, any suitable error/loss functions, or any suitable training termination criteria can be utilized during such training.

Although the herein disclosure mainly describes the machine learning model 406 as being trained in supervised fashion, this is a mere non-limiting example for ease of explanation and illustration. In various embodiments, any other suitable training paradigms can be used to train the machine learning model 406, such as unsupervised training, semi-supervised training, or reinforcement learning, any of which may be federated or unfederated.

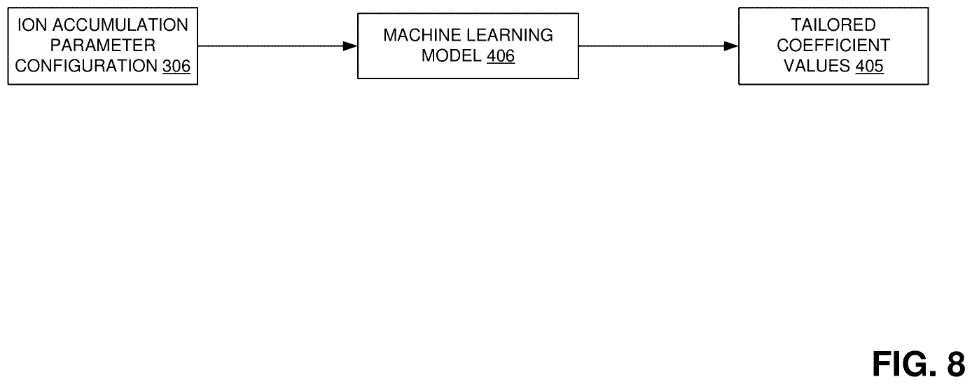

Now, consider FIG. 8. After the machine learning model 406 is trained, the model component 318 can electronically execute the machine learning model 406 on the ion accumulation parameter configuration 306, and such execution can cause the machine learning model 406 to produce the set of tailored coefficient values 405. More specifically, suppose that the machine learning model 406 exhibits a deep learning neural network internal architecture. In such situation, the model component 318 can electronically feed the ion accumulation parameter configuration 306 to the input layer of the machine learning model 406, the ion accumulation parameter configuration 306 can complete a forward pass through the one or more hidden layers of the machine learning model 406, and the output layer of the machine learning model 406 can compute or calculate the set of tailored coefficient values 405, based on whatever hidden activation maps or hidden feature maps are produced by the one or more hidden layers during the forward pass.

In any case, the set of tailored coefficient values 405 can be considered as specifying whatever particular scalar values that, if assigned to the set of coefficients 404, the machine learning model 406 believes would cause the ion trap filling function 402 to correctly, accurately, or reliably represent the ion accumulation behavior of the mass analyzer 304, when the mass analyzer 304 operates or functions according to the ion accumulation parameter configuration 306.

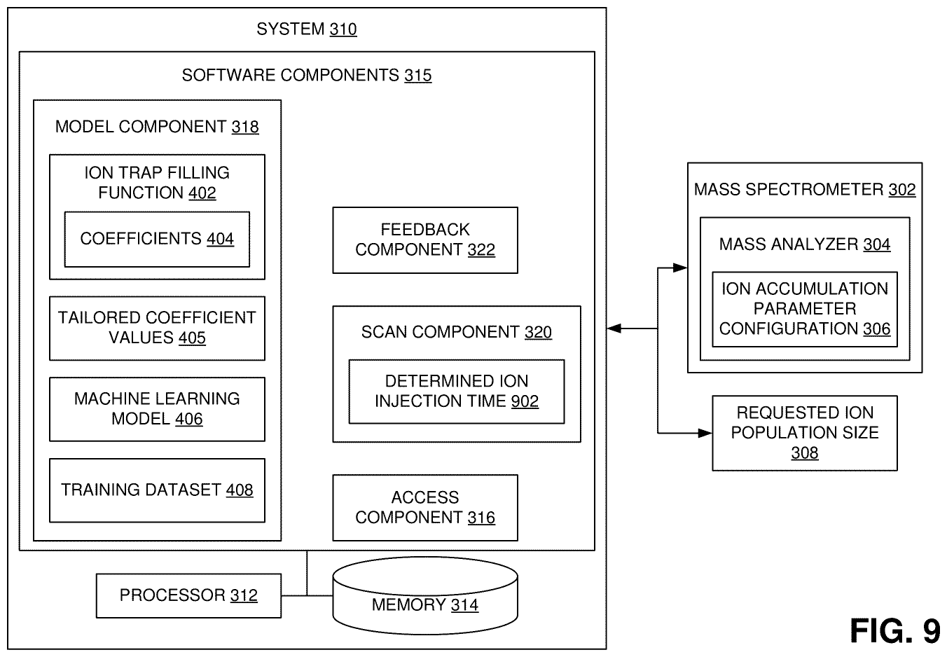

FIG. 9 illustrates a block diagram of an example, non-limiting system including a determined ion injection time that can facilitate machine learning prediction of ion trap filling functions in accordance with one or more embodiments described herein.

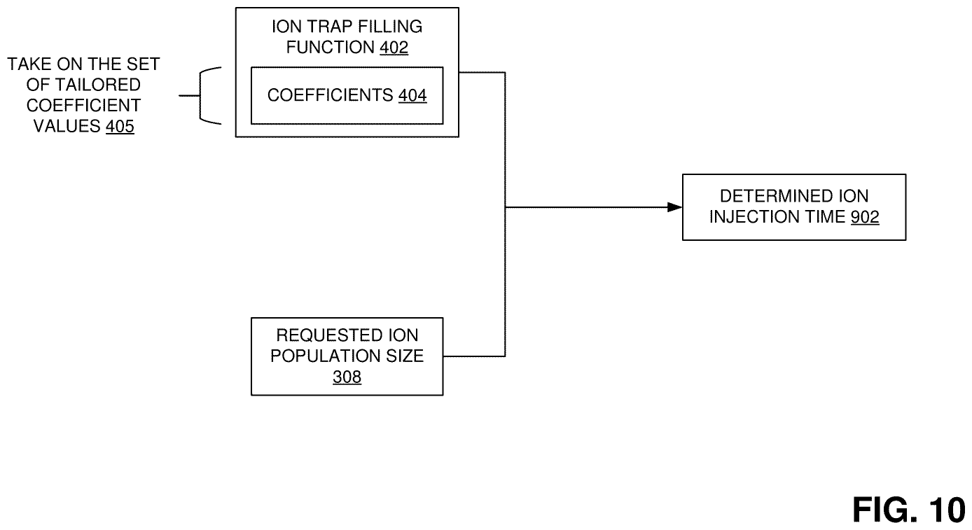

In various embodiments, the scan component 320 can electronically compute or identify a determined ion injection time 902, based on the set of tailored coefficient values 405. In various aspects, the determined ion injection time 902 can be a real-valued scalar that represents an ion injection time or ion injection duration that is predicted to be needed, necessary, or requisite in order for the mass analyzer 304 to achieve the requested ion population size 308, when the mass analyzer 304 operates or functions according to the ion accumulation parameter configuration 306. Various non-limiting aspects are described with respect to FIGS. 10-12.

FIGS. 10-12 illustrate example, non-limiting block diagrams showing how the determined ion injection time 902 can be obtained using the ion trap filling function 402 with the set of tailored coefficient values 405 in accordance with one or more embodiments described herein.

First, consider FIG. 10. In various embodiments, the scan component 320 can electronically compute the determined ion injection time 902 based on the set of tailored coefficient values 405 and based on the requested ion population size 308. In particular, the scan component 320 can: assign the set of tailored coefficient values 405 to respective ones of the set of coefficients 404; and feed the requested ion population size 308 as an input argument to the ion trap filling function 402. As a non-limiting example, suppose that the ion trap filling function 402 is given by

$$f ( p ) = a + {be}^{\frac{p}{c}} .$$

In such case, the set of tailored coefficient values 405 can be respectively assigned to a, b, and c, and the determined ion injection time 902 can be equal to ƒ(pᵣ) where pᵣ is the requested ion population size 308.

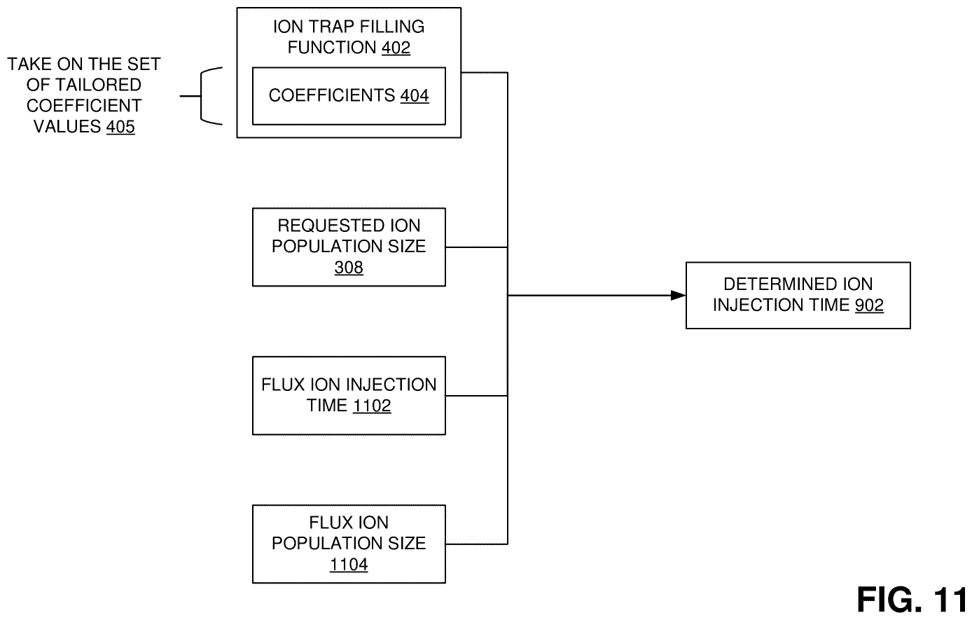

Next, consider FIG. 11. In various embodiments, the scan component 320 can electronically compute the determined ion injection time 902 based not only on the set of tailored coefficient values 405 and the requested ion population size 308, but also based on a flux ion injection time 1102 and a flux ion population size 1104. In particular, the flux ion injection time 1102 can be any suitable ion injection time that is of a short duration (e.g., mere milliseconds, or that is shorter than any suitable threshold length of time). In various aspects, the scan component 320 can electronically command, instruct, or otherwise cause the mass analyzer 304 (which is currently or presently set to the ion accumulation parameter configuration 306) to perform a scan (e.g., on any suitable sample or on no sample at all) according to the flux ion injection time 1102. In various instances, the scan component 320 can electronically measure the resulting ion population size that is accumulated in the ion trap during such scan, and this can be referred to as the flux ion population size 1104. It should be understood or otherwise appreciated that the flux ion injection time 1102 and the flux ion population size 1104 can collectively be referred to as an estimated ion flux associated with the mass analyzer 304. It should also be understood or otherwise appreciated that such estimated ion flux can be utilized in any suitable raw form or in any suitable corrected form (e.g., after one or more flux correction techniques are applied). In various cases, the scan component 320 can: assign the set of tailored coefficient values 405 to respective ones of the set of coefficients 404; feed the requested ion population size 308 as an input argument to the ion trap filling function 402, thereby yielding a first value; feed the flux ion population size 1104 as an input argument to the ion trap filling function 402, thereby yielding a second value; divide the first value by the second value, thereby yielding a ratio; and scale the flux ion injection time 1102 by that ratio. As a non-limiting example, suppose that the ion trap filling function 402 is given by

$$f ( p ) = a + {be}^{\frac{p}{c}} .$$

In such case, the set of tailored coefficient values 405 can be respectively assigned to a, b, and c, and the determined ion injection time 902 can be equal to

$${t}_{f} \frac{f ( {p}_{r} )}{f ( {p}_{f} )} ,$$

where pᵣ is the requested ion population size 308, where p_{f} is the flux ion population size 1104, and where t, is the flux ion injection time 1102.

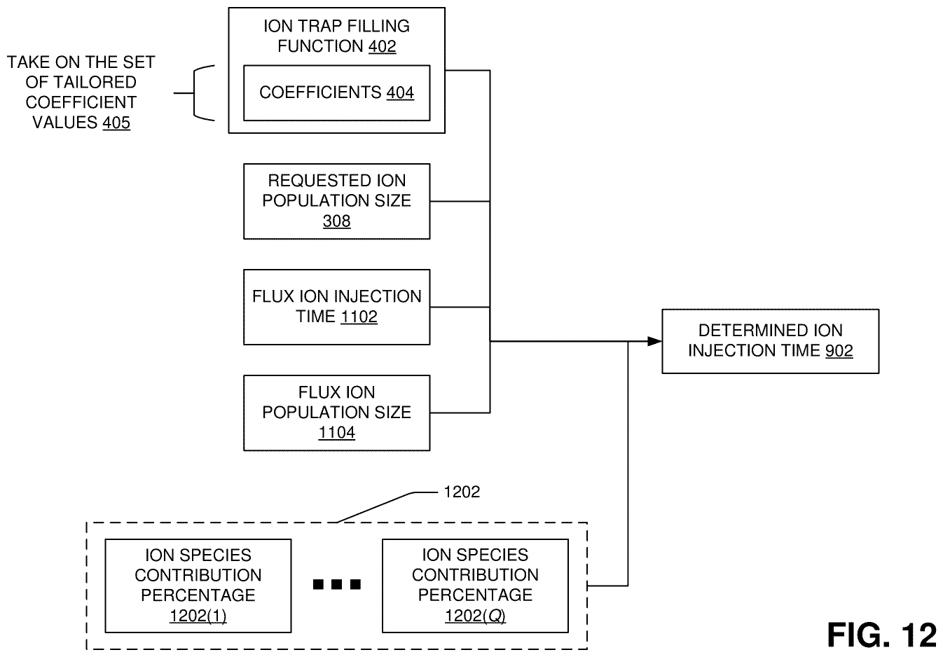

Now, consider FIG. 12. In various embodiments, the scan component 320 can electronically compute the determined ion injection time 902 based not only on the set of tailored coefficient values 405, the requested ion population size 308, the flux ion injection time 1102, and the flux ion population size 1104, but also based on an ion distribution 1202. Suppose that the mass spectrometer 302 is known or expected to perform scans using a total of q distinct ion species, for any suitable positive integer q. In such case, the ion distribution 1202 can be any suitable electronic data that specifies how much each respective one of those q ion species is known or expected to contribute to any given scan. As a non-limiting example, the ion distribution 1202 can include an ion species contribution percentage 1202(1), which can be a positive, real-valued scalar indicating, in percentage form, how much a first ion species utilized or employed by the mass spectrometer 302 is known, deemed, or expected to contribute to any given scan. As another non-limiting example, the ion distribution 1202 can include an ion species contribution percentage 1202(q), which can be a positive, real-valued scalar indicating, in percentage form, how much a q-th ion species utilized or employed by the mass spectrometer 302 is known, deemed, or expected to contribute to any given scan. In various situations, the sum of all the ion species contribution percentages in the ion distribution 1202 can be unity (e.g., can be 1). In various cases, the scan component 320 can: assign the set of tailored coefficient values 405 to respective ones of the set of coefficients 404; scale, for each of the q ion species, the requested ion population size 308 by a respective contribution percentage specified in the ion distribution 1202, thereby yielding a total of q scaled ion population sizes; feed each of those q scaled ion population sizes as an input argument to the ion trap filling function 402, thereby yielding a total of q first values; sum the total of q first values together, thereby yielding a second value; feed the flux ion population size 1104 as an input argument to the ion trap filling function 402, thereby yielding a third value; divide the second value by the third value, thereby yielding a ratio; and scale the flux ion injection time 1102 by that ratio. As a non-limiting example, suppose that the ion trap filling function 402 is given by

$$f ( p ) = a + {be}^{\frac{p}{c}} .$$

In such case, the set of tailored coefficient values 405 can be respectively assigned to a, b, and c, and the determined ion injection time 902 can be equal to

$${t}_{f} \frac{{\sum }_{i = 1}^{q} f ( {k}_{i} {p}_{r} )}{f ( {p}_{f} )} ,$$

where pᵣ is the requested ion population size 308, where p_{f} is the flux ion population size 1104, where t_{f} is the flux ion injection time 1102, where i is a summation index, where q is the total number of ion species implemented by the mass spectrometer 302, and where kᵢ is the contribution percentage of the i-th ion species (as specified in the ion distribution 1202).

In any case, the determined ion injection time 902 can be considered as that amount of time which is correlated to the requested ion population size 308 by the ion trap filling function 402, when the set of tailored coefficient values 405 are assigned to the set of coefficients 404. In other words, the determined ion injection time 902 can be considered as the ion injection time which is inferred or concluded to be needed, necessary, or requisite in order for the mass analyzer 304 to achieve the requested ion population size 308, when the mass analyzer 304 operates or functions according to the ion accumulation parameter configuration 306.

In various aspects, the scan component 320 can electronically instruct, electronically command, or otherwise electronically cause the mass spectrometer 302 to perform a scan (e.g., on any suitable sample or on no sample at all) using or otherwise implementing the determined ion injection time 902. Thus, it can have been desired for the mass spectrometer 302 to perform a scan in which the ion trap of the mass analyzer 304 achieves the requested ion population size 308, and the scan component 320 can be considered as accomplishing such desire.

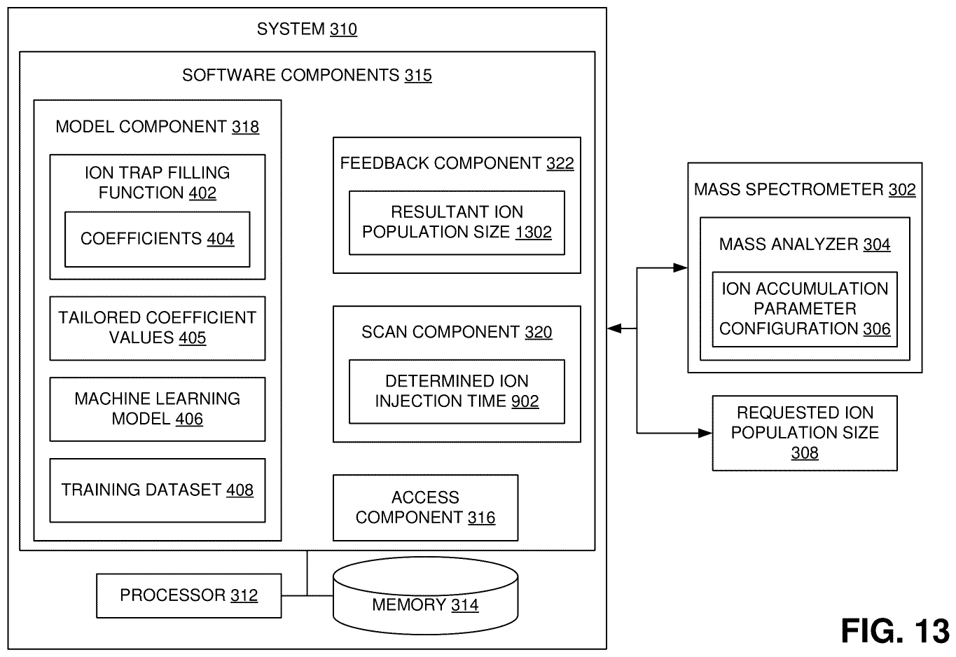

FIG. 13 illustrates a block diagram of an example, non-limiting system including a resultant ion population that can facilitate machine learning prediction of ion trap filling functions in accordance with one or more embodiments described herein.

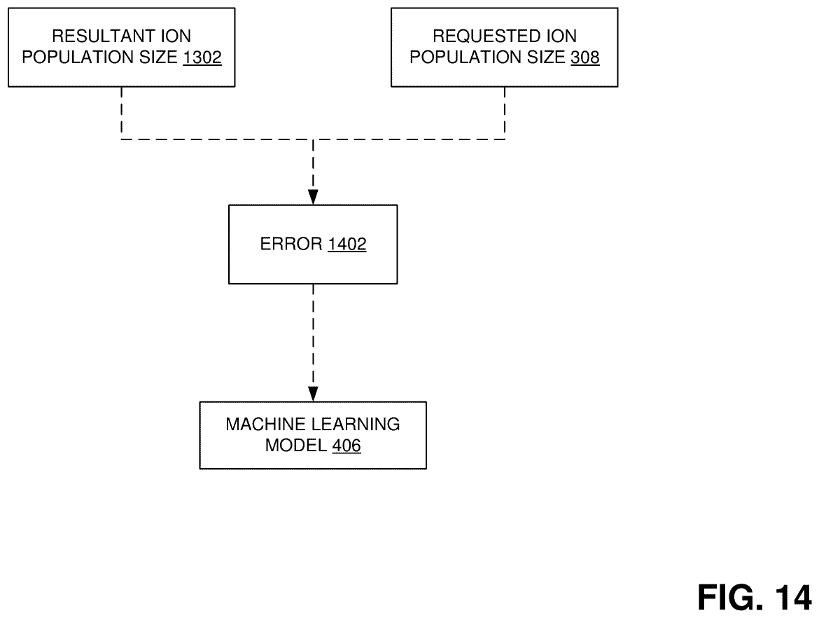

In various embodiments, the feedback component 322 can electronically measure (e.g., via any suitable ion population measuring technique) whatever actual ion population size is achieved by the ion trap of the mass analyzer 304 when the mass spectrometer 302 performs a scan using or implementing the determined ion injection time 902. Such measured ion population size can be referred to as a resultant ion population size 1302. In various aspects, the feedback component 322 can electronically update the machine learning model 406 in real-time, online, or on-the-fly fashion, based on the resultant ion population size 1302. Various non-limiting aspects are described with respect to FIG. 14.

FIG. 14 illustrates an example, non-limiting block diagram showing how the resultant ion population size 1302 can be used to update the machine learning model 406 in accordance with one or more embodiments described herein.

In various aspects, the requested ion population size 308 can be considered as the ion population size that is desired or expected to be achieved when the mass spectrometer 302 implements the determined ion injection time 902. In contrast, the resultant ion population size 1302 can be considered as the ion population size that is actually achieved when the mass spectrometer 302 implements the determined ion injection time 902. In various instances, the feedback component 322 can electronically compute an error 1402 (e.g., mean absolute error, mean squared error, cross-entropy error, percentage difference) between the requested ion population size 308 and the resultant ion population size 1302. In various cases, the feedback component 322 can incrementally update, via backpropagation (e.g., stochastic gradient descent), the trainable internal parameters (e.g., convolutional kernels, weight matrices) of the machine learning model 406 based on the error 1402. In this way, the machine learning model 406 can be considered as being updated in real-time or on-the-fly fashion based on any difference between the ion population sizes that are desired and the ion population sizes that are actually achieved through or via the predictions produced by the machine learning model 406.

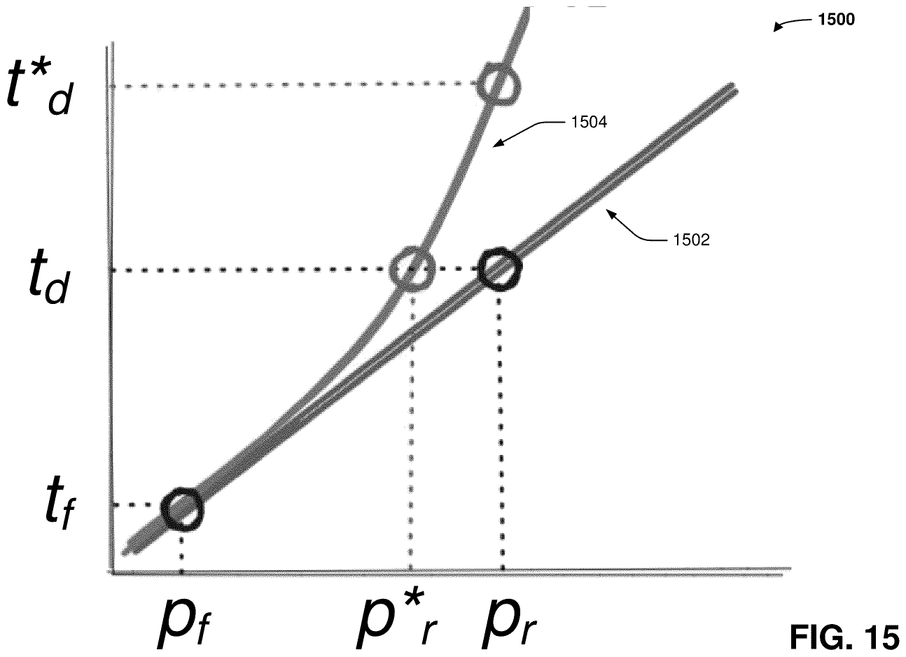

FIG. 15 illustrates an example, non-limiting graph 1500 illustrating a difference between linear and non-linear ion trap filling models in accordance with one or more embodiments described herein. The abscissa (e.g., horizontal) axis in the graph 1500 represents ion population size, whereas the ordinate (e.g., vertical) axis in the graph 1500 instead represents ion injection time needed to achieve a respective ion population size. Numeral 1502 shows a linear ion trap filling model, whereas numeral 1504 shows an exponential growth ion trap filling model. In the notation of FIG. 15, p_{f} represents the flux ion population size 1104, t_{f} represents the flux ion injection time 1102, and pᵣ represents the requested ion population size 308. In various aspects, ta represents the ion injection time that would be determined as needed, necessary, or requisite to achieve pᵣ, assuming that the ion trap accumulates ions in a linear fashion, which is not realistic. In various instances,

$${p}_{r}^{*}$$

represents the ion population size that would actually be achieved by t_{d}, since the ion trap accumulates ions in an exponential growth fashion rather than a linear fashion. In other words, a linear ion trap filling model indicates that ta would achieve pᵣ, but t_{d} in actuality significantly undershoots pᵣ. In various cases,

$${t}_{d}^{*}$$

represents the ion injection time that would actually be needed, necessary, or requisite to achieve pᵣ, since the ion trap accumulates ions in an exponential growth fashion rather than a linear fashion. In other words, a linear ion trap filling model indicates that t_{d} would achieve pᵣ, but an ion injection time significantly longer than t_{d} in actuality is needed to achieve pᵣ.

The graph 1500 helps to demonstrate: how existing techniques achieve deteriorated performance of automatic gain control; and how various embodiments described herein can achieve improved or better performance of automatic gain control. In particular, when given p_{f}, tᵣ, and pᵣ, existing techniques determine what ion injection time to implement by assuming a linear ion trap filling model that does not take into account the actual ion accumulation parameters of the mass analyzer 304 (e.g., existing techniques choose

$${t}_{d} = {t}_{f} \frac{{p}_{r}}{{p}_{f}} ;$$

not how this does not depend on or vary with ion accumulation parameter configuration). In stark contrast, various embodiments described herein can predict a non-linear exponential growth function that better models the ion accumulation behavior of the mass analyzer 304 (e.g., various embodiments described here can choose

$${t}_{d}^{*} = {t}_{f} \frac{g ( {p}_{r} )}{g ( {p}_{f} )} ,$$

where g represents the predicted non-linear exponential growth function which varies with ion accumulation parameter configuration). Accordingly, various embodiments described herein can avoid or reduce the problem of ion injection time undershooting the plagues existing techniques.

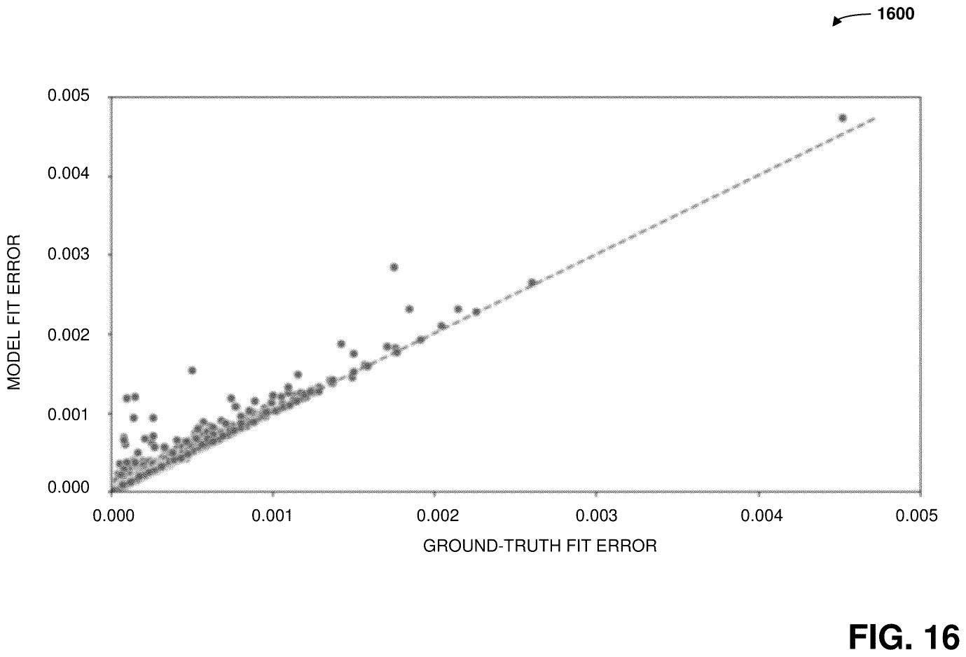

FIG. 16 illustrates some example, non-limiting experimental data in accordance with one or more embodiments described herein. In particular, the present inventors reduced to practice an embodiment of the machine learning model 406. In such reduction to practice, the machine learning model 406 exhibited a random forest regressor internal architecture, and the ion trap filling function 402 has the form

$$f ( p ) = a + {be}^{\frac{p}{c}} .$$

Just as described above, the training dataset 408 was obtained empirically, such that each training ion accumulation parameter configuration corresponded to a respective plot of ion injection time versus measured ion population size. To evaluate the efficacy of the machine learning model 406 post training, each plot of ion injection time versus measured ion population size was analyzed as follows: (1) mean squared error was computed between that plot and whatever version of the ion trap filling function 402 was fitted via least sum of squares to that plot; and (2) mean squared error was computed between that plot and whatever version of the ion trap filling function 402 was predicted by the machine learning model 406 in response to the training ion accumulation parameter configuration corresponding to that plot.

As a non-limiting example, one particular plot of ion injection time versus measured ion population size was produced for the following ion accumulation parameter configuration: scan range of 50 m/z to 120 m/z; and pass-range of 69 m/z to 70 m/z. Least sum of squares caused a, b, and c to have the following respective values: −0.1216, 0.1197, and 0.4476. This yielded a mean squared error of 1.415e-4 between that first particular plot and the ion trap filling function 402. In contrast, the machine learning model 406 predicted a, b, and c to have the following respective values: −0.1514, 0.1487, and 0.4825. This yielded a mean squared error of 4.151e-4 between that first particular plot and the ion trap filling function 402.

As another non-limiting example, a second particular plot of ion injection time versus measured ion population size was produced for the following ion accumulation parameter configuration: scan range of 200 m/z to 2000 m/z; and pass-range of 1297 m/z to 1347 m/z. Least sum of squares caused a, b, and c to have the following respective values: −0.7808, 0.7744, and 1.1903. This yielded a mean squared error of 4.196e-4 between that second particular plot and the ion trap filling function 402. In contrast, the machine learning model 406 predicted a, b, and c to have the following respective values: −0.7693, 0.7635, and 1.1718. This yielded a mean squared error of 4.149e-4 between that second particular plot and the ion trap filling function 402.

The computed mean squared errors from such experiment are shown in a graph 1600. The abscissa axis of the graph 1600 represents mean squared error between any given plot and the version of the ion trap filling function 402 computed via least sum of squares. In contrast, the ordinate axis of the graph 1600 represents mean squared error between any given plot and the version of the ion trap filling function 402 predicted by the machine learning model 406. As shown, the mean squared errors neatly fall on the y=x diagonal, meaning that the machine learning model 406 exhibited performance that closely matched that of least sum of squares. In other words, the machine learning model 406 successfully learned how to accurately predict the coefficients of the ion trap filling function 402 in response to inputted ion accumulation parameter configurations.

It should be understood or otherwise appreciated that any suitable data processing techniques (e.g., normalization) can be implemented in conjunction with any embodiments described herein. Indeed, implementing data normalization, particularly in embodiments in which the determined ion injection time 902 is computed based on the flux ion injection time 1102 and the flux ion population size 1104 (e.g., as described with respect to FIG. 11 or FIG. 12), can help to promote or increase portability or generalizability of the machine learning model 406 across different instruments, different instrument conditions, or different sample conditions. In particular, consider again FIG. 6. As mentioned above, the empirical data 601 can be considered as forming a plot whose abscissa axis represents ion population size (e.g., 604) and whose ordinate axis represents measured ion injection time (e.g., 602). In various aspects, the abscissa axis of such plot can be normalized in any suitable fashion so as to range from a minimum value of 0 to a maximum value of 1. As a non-limiting example, a maximum ion population size that can possibly be implemented or reached by the mass spectrometer 302 can be represented by a normalized value of 1, a null or empty ion population size can be represented by a normalized value of 0, and each of the plurality of ion population sizes 604 can correspond to a normalized value which proportionally indicates where that ion population size is located in between that maximum ion population size and that null or empty ion population size. As another non-limiting example, whichever of the plurality of ion population sizes 604 is greatest can be represented by a normalized value of 1, whichever of the plurality of ion population sizes 604 is least can be represented by a normalized value of 0, and each remaining one of the plurality of ion population sizes 604 can correspond to a normalized value which proportionally indicates where that ion population size is located in between that greatest ion population size and that least ion population size. Likewise, the ordinate axis of such plot can be normalized in any suitable fashion so as to range from a minimum value of 0 to a maximum value of 1. As a non-limiting example, a maximum ion injection time that can possibly be implemented by the mass spectrometer 302 can be represented by a normalized value of 1, a null or nonexistent ion injection time can be represented by a normalized value of 0, and each of the plurality of ion injection times 602 can correspond to a normalized value which proportionally indicates where that ion injection time is located in between that maximum ion injection time and that null or nonexistent ion injection time. As another non-limiting example, whichever of the plurality of ion injection times 602 is greatest can be represented by a normalized value of 1, whichever of the plurality of ion injection times 602 is least can be represented by a normalized value of 0, and each remaining one of the plurality of ion injection times 602 can correspond to a normalized value which proportionally indicates where that ion injection time is located in between that greatest ion injection time and that least ion injection time. As yet another non-limiting example, whatever injection time that is associated with the ion population size whose normalized value is 1 can be represented by a normalized value of 1, whatever injection time that is associated with the ion population size whose normalized value is 0 can be represented by a normalized value of 0, and each remaining one of the plurality of ion injection times 602 can correspond to a normalized value which proportionally indicates where that ion injection time is located in between those normalized extremes. In any case, when such normalization is implemented, the ion trap filling function 402 can (after fitting via least sum of squares) be considered as mapping normalized ion population size to normalized ion injection time (as opposed to mapping raw ion population size to raw ion injection time). In such situations, training of the machine learning model 406 as described herein can cause the machine learning model 406 to be configured to receive as input a ion accumulation parameter configuration and to produce as output which values of the set of coefficients 404 would cause the ion trap filling function 402 to properly, accurately, or reliably map normalized ion population size to normalized ion injection time, when the mass analyzer 304 operates according to that inputted ion accumulation parameter configuration.

Although the herein disclosure has mainly described various embodiments in which machine learning prediction of ion trap filling functions is applied to ion traps that are associated with mass analyzers, these are mere non-limiting examples for ease of explanation and illustration. In various other embodiments, machine learning prediction of ion trap filling functions can be applied to any suitable ion traps, even to ion traps that are not associated with mass analyzers. As a non-limiting example, a linear ion trap can, in some cases, pass or emit trapped ions into a downstream mass analyzer or can, in other cases, pass or emit trapped ions into any other suitable type of downstream device that is not a mass analyzer. In either situation, machine learning can be leveraged as described herein so as to predict the true or accurate ion trap filling function of that linear ion trap.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 17 and the following discussion are intended to provide a brief, general description of a suitable computing environment 1700 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), one or more external storage devices 1716 (e.g., a magnetic floppy disk drive (FDD) 1716, a memory stick or flash drive reader, a memory card reader, etc.) and a drive 1720, e.g., such as a solid state drive, an optical disk drive, which can read or write from a disk 1722, such as a CD-ROM disc, a DVD, a BD, etc. Alternatively, where a solid state drive is involved, disk 1722 would not be included, unless separate. While the internal HDD 1714 is illustrated as located within the computer 1702, the internal HDD 1714 can also be configured for external use in a suitable chassis (not shown). Additionally, while not shown in environment 1700, a solid state drive (SSD) could be used in addition to, or in place of, an HDD 1714. The HDD 1714, external storage device(s) 1716 and drive 1720 can be connected to the system bus 1708 by an HDD interface 1724, an external storage interface 1726 and a drive interface 1728, respectively. The interface 1724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can be enable with a security module, such as a trusted processing module (TPM). For instance with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1754 through a wired or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the Internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are example and other means of establishing a communications link between the computers can be used.

When used in either a LAN or WAN networking environment, the computer 1702 can access cloud storage systems or other network-based storage systems in addition to, or in place of, external storage devices 1716 as described above, such as but not limited to a network virtual machine providing one or more aspects of storage or processing of information. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 18 is a schematic block diagram of a sample computing environment 1800 with which the disclosed subject matter can interact. The sample computing environment 1800 includes one or more client(s) 1810. The client(s) 1810 can be hardware or software (e.g., threads, processes, computing devices). The sample computing environment 1800 also includes one or more server(s) 1830. The server(s) 1830 can also be hardware or software (e.g., threads, processes, computing devices). The servers 1830 can house threads to perform transformations by employing one or more embodiments as described herein, for example. One possible communication between a client 1810 and a server 1830 can be in the form of a data packet adapted to be transmitted between two or more computer processes. The sample computing environment 1800 includes a communication framework 1850 that can be employed to facilitate communications between the client(s) 1810 and the server(s) 1830. The client(s) 1810 are operably connected to one or more client data store(s) 1820 that can be employed to store information local to the client(s) 1810. Similarly, the server(s) 1830 are operably connected to one or more server data store(s) 1840 that can be employed to store information local to the servers 1830.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.

EXAMPLE 1: A system can comprise: a processor that executes computer-executable components stored in a non-transitory computer-readable memory, wherein the computer-executable components can comprise: an access component that can access a requested ion population size; and a scan component that can cause a mass analyzer to perform a scan using an injection time correlated to the requested ion population size by an ion trap filling function, wherein a coefficient set of the ion trap filling function can be predicted by a machine learning model based on a current operational parameter configuration of the mass analyzer.

EXAMPLE 2: The system of any preceding example can be implemented, wherein the computer-executable components can comprise: a model component that can feed the current operational parameter configuration as input to the machine learning model, wherein the machine learning model can produce as output the coefficient set.

EXAMPLE 3: The system of any preceding example can be implemented, wherein the model component can train the machine learning model in supervised fashion on a training dataset, wherein the training dataset can comprise: a plurality of operational parameter configurations that are implementable by the mass analyzer; and a plurality of ground-truth coefficient sets that respectively correspond to the plurality of operational parameter configurations.

EXAMPLE 4: The system of any preceding example can be implemented, wherein the access component can access an ion flux estimate comprising a flux injection time and a flux ion population size achieved by the flux injection time, and wherein the model component can: apply the ion trap filling function to the requested ion population size, thereby yielding a first value; apply the ion trap filling function to the flux ion population size, thereby yielding a second value; divide the first value by the second value, thereby yielding a ratio; and compute the injection time, based on scaling the flux injection time with the ratio.

EXAMPLE 5: The system of any preceding example can be implemented, wherein the access component can access an ion flux estimate comprising a flux injection time and a flux ion population size achieved by the flux injection time, wherein the access component can access an ion distribution indicating a respective contribution percentage for each of a plurality of ion species that are employed by the mass analyzer, and wherein the model component can: scale, for each of the plurality of ion species, the requested ion population size by a respective contribution percentage, thereby yielding a plurality of scaled ion population sizes; apply the ion trap filling function to each of the plurality of scaled ion population sizes, thereby yielding a plurality of first values; sum the plurality of first values, thereby yielding a second value; apply the ion trap filling function to the flux ion population size, thereby yielding a third value; divide the second value by the third value, thereby yielding a ratio; and compute the injection time, based on scaling the flux injection time with the ratio.

EXAMPLE 6: The system of any preceding example can be implemented, wherein the current operational parameter configuration can comprise: an initial mass, final mass, center mass, or width of a scan range currently implemented by the mass analyzer; an initial mass, final mass, center mass, or width of a pass range currently implemented by an ion trap of the mass analyzer; or a number of stacked ring ion guide injections currently implemented by the mass analyzer.

EXAMPLE 7: The system of any preceding example can be implemented, wherein the machine learning model can be a random forest regressor or a deep learning neural network.

EXAMPLE 8: The system of any preceding example can be implemented, wherein the ion trap filling function can be non-linear.

EXAMPLE 9: The system of any preceding example can be implemented, wherein the computer-executable components further can comprise: a feedback component that can: measure an actual ion population size achieved by the injection time; compute an error between the actual ion population size and the requested ion population size; and update, via backpropagation, the machine learning model based on the error.

In various embodiments, any combination or combinations of examples 1-9 can be implemented.

EXAMPLE 10: A computer-implemented method can comprise: accessing, by a device operatively coupled to a processor, a requested ion population size; and causing, by the device, a mass analyzer to perform a scan using an injection time correlated to the requested ion population size by an ion trap filling function, wherein a coefficient set of the ion trap filling function is predicted by a machine learning model based on a current operational parameter configuration of the mass analyzer.

EXAMPLE 11: The computer-implemented method of any preceding example can be implemented, further comprising: feeding, by the device, the current operational parameter configuration as input to the machine learning model, wherein the machine learning model can produce as output the coefficient set.

EXAMPLE 12: The computer-implemented method of any preceding example can be implemented, further comprising: training, by the device, the machine learning model in supervised fashion on a training dataset, wherein the training dataset can comprise: a plurality of operational parameter configurations that are implementable by the mass analyzer; and a plurality of ground-truth coefficient sets that respectively correspond to the plurality of operational parameter configurations.

EXAMPLE 13: The computer-implemented method of any preceding example can be implemented, further comprising: accessing, by the device, an ion flux estimate comprising a flux injection time and a flux ion population size achieved by the flux injection time; applying, by the device, the ion trap filling function to the requested ion population size, thereby yielding a first value; applying, by the device, the ion trap filling function to the flux ion population size, thereby yielding a second value; dividing, by the device, the first value by the second value, thereby yielding a ratio; and computing, by the device, the injection time, based on scaling the flux injection time with the ratio.

EXAMPLE 14: The computer-implemented method of any preceding example can be implemented, further comprising: accessing, by the device, an ion flux estimate comprising a flux injection time and a flux ion population size achieved by the flux injection time; accessing, by the device, an ion distribution indicating a respective contribution percentage for each of a plurality of ion species that are employed by the mass analyzer; scaling, by the device and for each of the plurality of ion species, the requested ion population size by a respective contribution percentage, thereby yielding a plurality of scaled ion population sizes; applying, by the device, the ion trap filling function to each of the plurality of scaled ion population sizes, thereby yielding a plurality of first values; summing, by the device, the plurality of first values, thereby yielding a second value; applying, by the device, the ion trap filling function to the flux ion population size, thereby yielding a third value; dividing, by the device, the second value by the third value, thereby yielding a ratio; and computing, by the device, the injection time, based on scaling the flux injection time with the ratio.

EXAMPLE 15: The computer-implemented method of any preceding example can be implemented, wherein the current operational parameter configuration can comprise: an initial mass, final mass, center mass, or width of a scan range currently implemented by the mass analyzer; an initial mass, final mass, center mass, or width of a pass range currently implemented by an ion trap of the mass analyzer; or a number of stacked ring ion guide injections currently implemented by the mass analyzer.

EXAMPLE 16: The computer-implemented method of any preceding example can be implemented, wherein the machine learning model can be a random forest regressor or a deep learning neural network.

EXAMPLE 17: The computer-implemented method of any preceding example can be implemented, wherein the ion trap filling function can be non-linear.

EXAMPLE 18: The computer-implemented method of any preceding example can be implemented, further comprising: measuring, by the device, an actual ion population size achieved by the injection time; computing, by the device, an error between the actual ion population size and the requested ion population size; and updating, by the device and via backpropagation, the machine learning model based on the error.

In various embodiments, any combination or combinations of examples 10-18 can be implemented.

EXAMPLE 19: A computer program product for facilitating machine learning prediction of ion trap filling functions can comprise a non-transitory computer-readable memory having program instructions embodied therewith. In various aspects, the program instructions can be executable by a processor to cause the processor to: access a requested ion population size; and cause a mass analyzer to perform a scan using an injection time correlated to the requested ion population size by an ion trap filling function, wherein a coefficient set of the ion trap filling function is predicted by a machine learning model based on a current operational parameter configuration of the mass analyzer.

EXAMPLE 20: The computer program product of any preceding example can be implemented, wherein the program instructions are executable to cause the processor to: feed the current operational parameter configuration as input to the machine learning model, wherein the machine learning model produces as output the coefficient set.

In various embodiments, any combination or combinations of examples 19-20 can be implemented.

In various embodiments, any combination or combinations of examples 1-20 can be implemented.

What is claimed is:

1. A system, comprising:
a processor that executes computer-executable components stored in a non-transitory computer-readable memory, wherein the computer-executable components comprise:
an access component that accesses a requested ion population size; and
a scan component that causes a mass analyzer to perform a scan using an injection time correlated to the requested ion population size by an ion trap filling function, wherein a coefficient set of the ion trap filling function is predicted by a machine learning model based on a current operational parameter configuration of the mass analyzer.

2. The system of claim 1, wherein the computer-executable components further comprise:
a model component that feeds the current operational parameter configuration as input to the machine learning model, wherein the machine learning model produces as output the coefficient set.

3. The system of claim 2, wherein the model component trains the machine learning model in supervised fashion on a training dataset, wherein the training dataset comprises:
a plurality of operational parameter configurations that are implementable by the mass analyzer; and
a plurality of ground-truth coefficient sets that respectively correspond to the plurality of operational parameter configurations.

4. The system of claim 2, wherein the access component accesses an ion flux estimate comprising a flux injection time and a flux ion population size achieved by the flux injection time, and wherein the model component:
applies the ion trap filling function to the requested ion population size, thereby yielding a first value;
applies the ion trap filling function to the flux ion population size, thereby yielding a second value;
divides the first value by the second value, thereby yielding a ratio; and
computes the injection time, based on scaling the flux injection time with the ratio.

5. The system of claim 2, wherein the access component accesses an ion flux estimate comprising a flux injection time and a flux ion population size achieved by the flux injection time, wherein the access component accesses an ion distribution indicating a respective contribution percentage for each of a plurality of ion species that are employed by the mass analyzer, and wherein the model component:
scales, for each of the plurality of ion species, the requested ion population size by a respective contribution percentage, thereby yielding a plurality of scaled ion population sizes;
applies the ion trap filling function to each of the plurality of scaled ion population sizes, thereby yielding a plurality of first values;
sums the plurality of first values, thereby yielding a second value;
applies the ion trap filling function to the flux ion population size, thereby yielding a third value;
divides the second value by the third value, thereby yielding a ratio; and
computes the injection time, based on scaling the flux injection time with the ratio.

6. The system of claim 2, wherein the current operational parameter configuration comprises: an initial mass, final mass, center mass, or width of a scan range currently implemented by the mass analyzer; an initial mass, final mass, center mass, or width of a pass range currently implemented by an ion trap of the mass analyzer; or a number of stacked ring ion guide injections currently implemented by the mass analyzer.

7. The system of claim 1, wherein the machine learning model is a random forest regressor or a deep learning neural network.

8. The system of claim 1, wherein the ion trap filling function is non-linear.

9. The system of claim 1, wherein the computer-executable components further comprise:
a feedback component that:
measures an actual ion population size achieved by the injection time;
computes an error between the actual ion population size and the requested ion population size; and
updates, via backpropagation, the machine learning model based on the error.

10. A computer-implemented method, comprising:
accessing, by a device operatively coupled to a processor, a requested ion population size; and
causing, by the device, a mass analyzer to perform a scan using an injection time correlated to the requested ion population size by an ion trap filling function, wherein a coefficient set of the ion trap filling function is predicted by a machine learning model based on a current operational parameter configuration of the mass analyzer.

11. The computer-implemented method of claim 10, further comprising:
feeding, by the device, the current operational parameter configuration as input to the machine learning model, wherein the machine learning model produces as output the coefficient set.

12. The computer-implemented method of claim 11, further comprising:
training, by the device, the machine learning model in supervised fashion on a training dataset, wherein the training dataset comprises:
a plurality of operational parameter configurations that are implementable by the mass analyzer; and
a plurality of ground-truth coefficient sets that respectively correspond to the plurality of operational parameter configurations.

13. The computer-implemented method of claim 11, further comprising:
accessing, by the device, an ion flux estimate comprising a flux injection time and a flux ion population size achieved by the flux injection time;
applying, by the device, the ion trap filling function to the requested ion population size, thereby yielding a first value;
applying, by the device, the ion trap filling function to the flux ion population size, thereby yielding a second value;
dividing, by the device, the first value by the second value, thereby yielding a ratio; and
computing, by the device, the injection time, based on scaling the flux injection time with the ratio.

14. The computer-implemented method of claim 11, further comprising:
accessing, by the device, an ion flux estimate comprising a flux injection time and a flux ion population size achieved by the flux injection time;
accessing, by the device, an ion distribution indicating a respective contribution percentage for each of a plurality of ion species that are employed by the mass analyzer;
scaling, by the device and for each of the plurality of ion species, the requested ion population size by a respective contribution percentage, thereby yielding a plurality of scaled ion population sizes;
applying, by the device, the ion trap filling function to each of the plurality of scaled ion population sizes, thereby yielding a plurality of first values;
summing, by the device, the plurality of first values, thereby yielding a second value;
applying, by the device, the ion trap filling function to the flux ion population size, thereby yielding a third value;
dividing, by the device, the second value by the third value, thereby yielding a ratio; and
computing, by the device, the injection time, based on scaling the flux injection time with the ratio.

15. The computer-implemented method of claim 11, wherein the current operational parameter configuration comprises: an initial mass, final mass, center mass, or width of a scan range currently implemented by the mass analyzer; an initial mass, final mass, center mass, or width of a pass range currently implemented by an ion trap of the mass analyzer; or a number of stacked ring ion guide injections currently implemented by the mass analyzer.

16. The computer-implemented method of claim 10, wherein the machine learning model is a random forest regressor or a deep learning neural network.

17. The computer-implemented method of claim 10, wherein the ion trap filling function is non-linear.

18. The computer-implemented method of claim 10, further comprising:
measuring, by the device, an actual ion population size achieved by the injection time;
computing, by the device, an error between the actual ion population size and the requested ion population size;
updating, by the device and via backpropagation, the machine learning model based on the error.

19. A computer program product for facilitating machine learning prediction of ion trap filling functions, the computer program product comprising a non-transitory computer-readable memory having program instructions embodied therewith, the program instructions executable by a processor to cause the processor to:
access a requested ion population size; and
cause a mass analyzer to perform a scan using an injection time correlated to the requested ion population size by an ion trap filling function, wherein a coefficient set of the ion trap filling function is predicted by a machine learning model based on a current operational parameter configuration of the mass analyzer.

20. The computer program product of claim 19, wherein the program instructions are further executable to cause the processor to:
feed the current operational parameter configuration as input to the machine learning model, wherein the machine learning model produces as output the coefficient set.
